(19) United States
(12) Patent Application Publication
(10) Pub. No.: US 2009/0157358 A1
(43) Pub. Date: Jun. 18, 2009

(54) System for diagnosing and monitoring structural health conditions

(76) Inventor: Hyeung-Yun Kim, Palo Alto, CA (US)

Correspondence Address: PATENT OFFICE OF DR. CHUNG S. PARK, P. O. BOX 62312, SUNNYVALE, CA, 94088-2312, US

(21) Appl. No.: 12/214,896

(22) Filed: Jun. 23, 2008

Related U.S. Application Data
(63) Continuation-in-part of application No. 11/861,781, filed on Sep. 26, 2007, now abandoned.
Application No. 11/861,781 is a continuation of application No. 11/397,351, filed on Apr. 3, 2006, now Pat. No. 7,281,428.
Application No. 11/397,351 is a continuation of application No. 10/942,366, filed on Sep. 16, 2004, now Pat. No. 7,117,742.
(60) Provisional application No. 60/505,120, filed on Sep. 22, 2003.

(51) Int. Cl. G21C 17/00

(52) U.S. Cl. 702/185

(57) ABSTRACT

Systems for diagnosing/monitoring structural health conditions of objects. The system, which monitors structural health conditions by use of a plurality of patch sensors attached to an object, includes at least one bridge box and at least one relay switch array module having a plurality of switches. Each of the patch sensors is adapted to perform at least one of generating a wave upon receipt of an actuator signal and developing a sensor signal. The bridge box includes an analogue-to-digital converter (ADC) for converting the sensor signal to a digital signal. The switches are adapted to establish a channel between a selected one of the patch sensors and the ADC.

### CROSS REFERENCE TO RELATED APPLICATIONS

This application is a continuation-in-part of U.S. patent application Ser. No. 11/861,781, filed on Sep. 26, 2007, which is a continuation of U.S. patent application Ser. No. 11/397,351, filed on Apr. 3, 2006, now U.S. Pat. No. 7,281,428, which is a continuation of application Ser. No. 10/942,366, filed on Sep. 16, 2004, now U.S. Pat. No. 7,117,742, which claims the benefit of U.S. Provisional Applications No. 60/505,120, filed on Sep. 22, 2003.

### BACKGROUND

The present invention relates to diagnostics of structures, and more particularly to diagnostic network patch (DNP) systems for monitoring structural health conditions.

As all structures in service require appropriate inspection and maintenance, they should be monitored for their integrity and health condition to prolong their life or to prevent catastrophic failure. Apparently, the structural health monitoring has become an important topic in recent years. Numerous methods have been employed to identify fault or damage of structures, where these methods may include conventional visual inspection and non-destructive techniques, such as ultrasonic and eddy current scanning, acoustic emission and X-ray inspection. These conventional methods require at least temporary removal of structures from service for inspection. Although still used for inspection of isolated locations, they are time-consuming and expensive.

With the advance of sensor technologies, new diagnostic techniques for in-situ structural integrity monitoring have been in significant progress. Typically, these new techniques utilize sensory systems of appropriate sensors and actuators built in host structures. However, these approaches have drawbacks and may not provide effective on-line methods to implement a reliable sensory network system and/or accurate monitoring methods that can diagnose, classify and forecast structural condition with the minimum intervention of human operators. For example, U.S. Pat. No. 5,814,729, issued to Wu et al., discloses a method that detects the changes of damping characteristics of vibrational waves in a laminated composite structure to locate delaminated regions in the structure. Piezoceramic devices are applied as actuators to generate the vibrational waves and fiber optic cables with different grating locations are used as sensors to catch the wave signals. A drawback of this system is that it cannot accommodate a large number of actuator arrays and, as a consequence, each of actuators and sensors must be placed individually. Since the damage detection is based on the changes of vibrational waves traveling along the line-of-sight paths between the actuators and sensors, this method fails to detect the damage located out of the paths and/or around the boundary of the structure.

Another approach for damage detection can be found in U.S. Pat. No. 5,184,516, issued to Blazic et al., that discloses a self-contained conformal circuit for structural health monitoring and assessment. This conformal circuit consists of a series of stacked layers and traces of strain sensors, where each sensor measures strain changes at its corresponding location to identify the defect of a conformal structure. The conformal circuit is a passive system, i.e., it does not have any actuator for generating signals. A similar passive sensory network system can be found in U.S. Pat. No. 6,399,939, issued to Mannur, J. et al. In Mannur '939 patent, a piezoceramic-fiber sensory system is disclosed having planner fibers embedded in a composite structure. A drawback of these passive methods is that they cannot monitor internal delamination and damages between the sensors. Moreover, these methods can detect the conditions of their host structures only in the local areas where the self-contained circuit and the piezoceramic-fiber are affixed.

One method for detecting damages in a structure is taught by U.S. Pat. No. 6,370,964 (Chang et al.). Chang et al. discloses a sensory network layer, called Stanford Multi-Actuator-Receiver Transduction (SMART) Layer. The SMART Layer® includes piezoceramic sensors/actuators equidistantly placed and cured with flexible dielectric films sandwiching the piezoceramic sensors/actuators (or, shortly, piezoceramics). The actuators generate acoustic waves and sensors receive/transform the acoustic waves into electric signals. To connect the piezoceramics to an electronic box, metallic clad wires are etched using the conventional flexible circuitry technique and laminated between the substrates. As a consequence, a considerable amount of the flexible substrate area is needed to cover the clad wire regions. In addition, the SMART Layer® needs to be cured with its host structure made of laminated composite layers. Due to the internal stress caused by a high temperature cycle during the curing process, the piezoceramics in the SMART Layer® can be micro-fractured. Also, the substrate of the SMART Layer® can be easily separated from the host structure. Moreover, it is very difficult to insert or attach the SMART Layer® to its host structure having a curved section and, as a consequence, a compressive load applied to the curved section can easily fold the clad wires. Fractured piezoceramics and the folded wires may be susceptible to electromagnetic interference noise and provide misleading electrical signals. In harsh environments, such as thermal stress, field shock and vibration, the SMART Layer® may not be a robust and unreliable tool for monitoring structural health. Furthermore, the replacement of damaged and/or defective actuators/sensors may be costly as the host structure needs to be dismantled.

Another method for detecting damages in a structure is taught by U.S. Pat. No. 6,396,262 ( Light et al.). Light et al. discloses a sensor for inspecting structural damages, where the sensor includes a ferromagnetic strip and a coil closely located to the strip. The major drawback of this system is that the system cannot be designed to accommodate an array of sensors and, consequently, cannot detect internal damages located between sensors.

Thus, there is a need for an efficient, accurate and reliable system that can be readily integrated into existing and/or new structures and provide an effective on-line methodology to diagnose, classify and forecast structural condition with the minimum intervention of human operators.

### SUMMARY OF THE DISCLOSURE

According to one embodiment of the present invention, a diagnostic system for monitoring structural health conditions by use of a plurality of patch sensors attached to an object, each of the patch sensors being adapted to perform at least one of generating a wave upon receipt of an actuator signal and developing a sensor signal, includes: at least one bridge box having at least one analog-to-digital converter(ADC) for converting the sensor signal to a digital signal; and at least one relay switch array module that has a plurality of relay switches. The switches are adapted to establish a channel between a selected one of the patch sensors and the ADC.

### BRIEF DESCRIPTION OF THE DRAWINGS

FIG. 1A is a schematic top cut-away view of a pickup unit of a patch sensor in accordance with one embodiment of the present teachings.

FIG. 1B is a schematic side cross-sectional view of the patch sensor shown in FIG. 1A.

FIG. 1C is a schematic top view of a typical piezoelectric device.

FIG. 1D is a schematic side cross-sectional view of the typical piezoelectric device in FIG. 1C.

FIG. 1E is a schematic top cut-away view of a patch sensor in accordance with another embodiment of the present teachings.

FIG. 1F is a schematic side cross-sectional view of the patch sensor shown in FIG. 1E.

FIG. 1G is a schematic cross-sectional view of a composite laminate including the patch sensor of FIG. 1E.

FIG. 1H is a schematic side cross-sectional view of an alternative embodiment of the patch sensor of FIG. 1E.

FIG. 2A is a schematic top cut-away view of a pickup unit of a hybrid patch sensor in accordance with one embodiment of the present teachings.

FIG. 2B is a schematic side cross-sectional view of the hybrid patch sensor shown in FIG. 2A.

FIG. 2C is a schematic top cut-away view of a hybrid patch sensor in accordance with another embodiment of the present teachings.

FIG. 2D is a schematic side cross-sectional view of the hybrid patch sensor shown in FIG. 2C.

FIG. 3A is a schematic top cut-away view of a pickup unit of an optical fiber patch sensor in accordance with one embodiment of the present teachings.

FIG. 3B is a schematic side cross-sectional view of the optical fiber patch sensor shown in FIG. 3A.

FIG. 3C is a schematic top cut-away view of the optical fiber coil contained in the optical fiber patch sensor of FIG. 3A.

FIG. 3D is a schematic top cut-away view of an alternative embodiment of the optical fiber coil shown in FIG. 3C.

FIGS. 3E-F are schematic top cut-away views of alternative embodiments of the optical fiber coil of FIG. 3C.

FIG. 3G is a schematic side cross-sectional view of the optical fiber coil of FIG. 3E.

FIG. 4A is a schematic top cut-away view of a pickup unit of a diagnostic patch washer in accordance with one embodiment of the present teachings.

FIG. 4B is a schematic side cross-sectional view of the diagnostic patch washer shown in FIG. 4A.

FIG. 4C is a schematic diagram of an exemplary bolt-jointed structure using the diagnostic patch washer of FIG. 4A in accordance with one embodiment of the present teachings.

FIG. 4D is a schematic diagram of an exemplary bolt-jointed structure using the diagnostic patch washer of FIG. 4A in accordance with another embodiment of the present teachings.

FIG. 5A is a schematic diagram of an interrogation system including a sensor/actuator device in accordance with one embodiment of the present teachings.

FIG. 5B is a schematic diagram of an interrogation system including a sensor in accordance with one embodiment of the present teachings.

FIG. 6A is a schematic diagram of a diagnostic network patch system applied to a host structure in accordance with one embodiment of the present teachings.

FIG. 6B is a schematic diagram of a diagnostic network patch system having a strip network configuration in accordance with one embodiment of the present teachings.

FIG. 6C is a schematic diagram of a diagnostic network patch system having a pentagon network configuration in accordance with one embodiment of the present teachings.

FIG. 6D is a schematic perspective view of a diagnostic network patch system incorporated into rivet/bolt-jointed composite laminates in accordance with one embodiment of the present teachings.

FIG. 6E is a schematic perspective view of a diagnostic network patch system incorporated into a composite laminate repaired with a bonding patch in accordance with another embodiment of the present teachings.

FIG. 6F is a schematic diagram illustrating an embodiment of a wireless communication system that controls a remote diagnostic network patch system in accordance with one embodiment of the present teachings.

FIG. 7A is a schematic diagram of a diagnostic network patch system having clustered sensors in a strip network configuration in accordance with one embodiment of the present teachings.

FIG. 7B is a schematic diagram of a diagnostic network patch system having clustered sensors in a pentagonal network configuration in accordance with another embodiment of the present teachings.

FIG. 8A is a schematic diagram of a clustered sensor having optical fiber coils in a serial connection in accordance with one embodiment of the present teachings.

FIG. 8B is a schematic diagram of a clustered sensor having optical fiber coils in a parallel connection in accordance with another embodiment of the present teachings.

FIG. 9 is a plot of actuator and sensor signals in accordance with one embodiment of the present teachings.

FIG. 10A-14 are schematic diagrams of structural health monitoring systems having bridge boxes in accordance with various embodiments of the present teachings.

FIG. 15 is a schematic diagram of a structural health monitoring system in accordance with another embodiment of the present teachings.

### DETAILED DESCRIPTION OF THE PREFERRED EMBODIMENTS

Although the following detained description contains many specifics for the purposes of illustration, those of ordinary skill in the art will appreciate that many variations and alterations to the following detains are within the scope of the invention. Accordingly, the following embodiments of the invention are set forth without any loss of generality to, and without imposing limitation upon, the claimed invention.

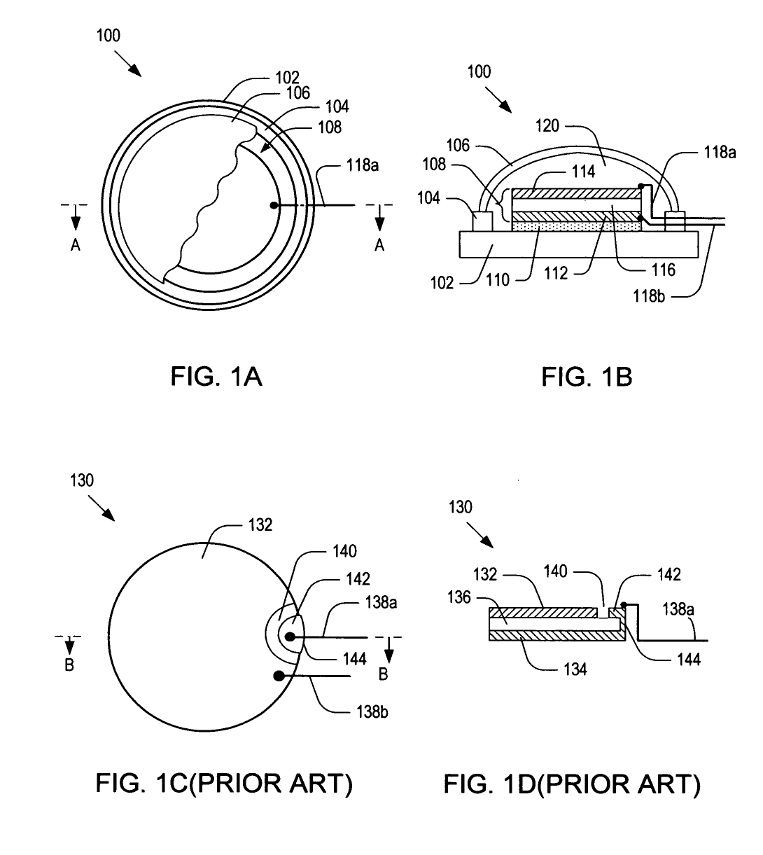

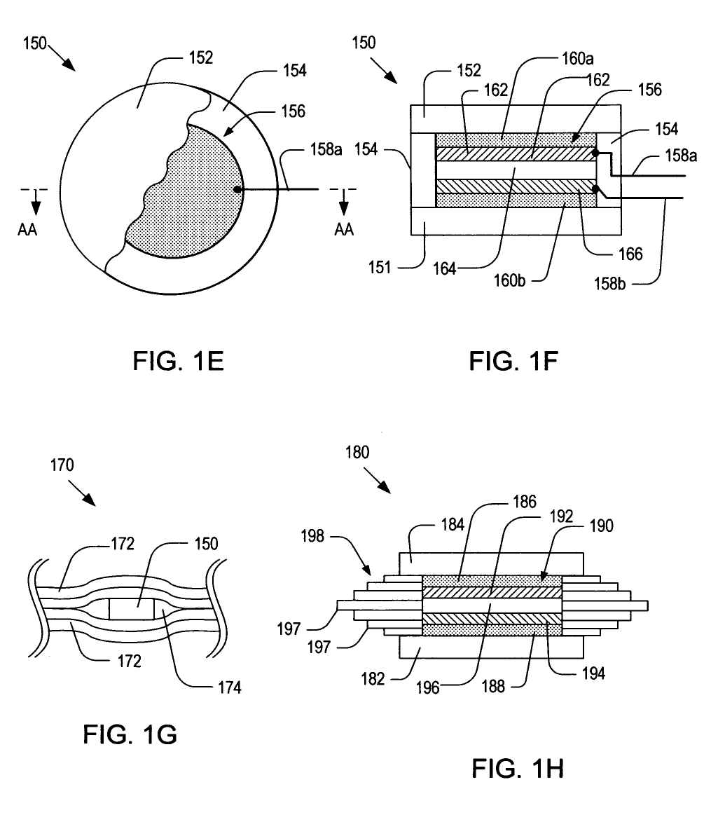

FIG. 1A is a schematic top cut-away view of a pickup unit of 100 of a patch sensor in accordance with one embodiment of the present teachings. Hereinafter, the terms “pickup unit of a patch sensor” and “patch sensor” are used interchangeably. FIG. 1B is a schematic cross-sectional view of the patch sensor 100 taken along a direction A-A of FIG. 1A. As shown in FIGS. 1A-B, the patch sensor 100 may include: a substrate 102 configured to attach to a host structure; a hoop layer 104; a piezoelectric device 108 for generating and/or receiving signals (more specifically, Lamb waves); a buffer layer 110 for providing mechanical impedance matching and reducing thermal stress mismatch between the substrate 102 and the piezoelectric device 108; two electrical wires 118a-b connected to the piezoelectric device 108; a molding layer 120 for securing the piezoelectric device 108 to the substrate 102; and a cover layer 106 for protecting and sealing the molding layer 120. The piezoelectric device 108 includes: a piezoelectric layer 116; a bottom conductive flake 112 connected to the electrical wire 118b; and a top conductive flake 114 connected to the electrical wire 118a. The piezoelectric device 108 may operate as an actuator (or, equivalently, signal generator) when a pre-designed electric signal is applied through the electric wires 118a-b. Upon application of an electrical signal, the piezoelectric layer 116 may deform to generate Lamb waves. Also, the piezoelectric device 108 may operate as a receiver for sensing vibrational signals, converting the vibrational signals applied to the piezoelectric layer 116 into electric signals and transmitting the electric signals through the wires 118a-b. The wires 118a-b may be a thin ribbon type metallic wire.

The substrate 102 may be attached to a host structure using a structural adhesive, typically a cast thermosetting epoxy, such as butyralthenolic, acrylic polyimide, nitriale phenolic or aramide. The substrate 102 may be an insulation layer for thermal heat and electromagnetic interference protecting the piezoelectric device 108 affixed to it. In some applications, the dielectric substrate 102 may need to cope with a temperature above 250° C. Also it may have a low dielectric constant to minimize signal propagation delay, interconnection capacitance and crosstalk between the piezoelectric device 108 and its host structure, and high impedance to reduce power loss at high frequency.

The substrate 102 may be made of various materials. Kapton® polyimide manufactured by DuPont, Wilmington, Del., may be preferably used for its commonplace while other three materials of Teflon perfluoroalkoxy (PFA), poly p-xylylene (PPX), and polybenzimidazole (PBI), can be used for their specific applications. For example, PFA film may have good dielectric properties and low dielectric loss to be suitable for low voltage and high temperature applications. PPX and PBI may provide stable dielectric strength at high temperatures.

The piezoelectric layer 116 can be made of piezoelectric ceramics, crystals or polymers. A piezoelectric crystal, such as PZN-PT crystal manufactured by TRS Ceramics, Inc., State College, Pa., may be preferably employed in the design of the piezoelectric device 108 due to its high strain energy density and low strain hysteresis. For small size patch sensors, the piezoelectric ceramics, such as PZT ceramics manufactured by Fuji Ceramic Corporation, Tokyo, Japan, or APC International, Ltd., Mackeyville, Pa., may be used for the piezoelectric layer 116. The top and bottom conductive flakes 112 and 114 may be made of metallic material, such as Cr or Au, and applied to the piezoelectric layer 116 by the conventional sputtering process. In FIG. 1B, the piezoelectric device 108 is shown to have only a pair of conductive flakes. However, it should be apparent to those of ordinary skill that the piezoelectric device 108 may have the multiple stacks of conductive flakes having various thicknesses to optimize the performance of the piezoelectric layer 116 in generating/detecting signal waves. The thickness of each flake may be determined by the constraints of thermal and mechanical loads given in a particular host structure that the patch sensor 100 is attached to.

To sustain temperature cycling, each layer of the piezoelectric device 108 may need to have a thermal expansion coefficient similar to those of other layers. Yet, the coefficient of a typical polyimide comprising the substrate 102 may be about 4-6×10⁻⁵ K⁻¹ while that of a typical piezoelectric ceramic/crystal comprising the piezoelectric layer 116 may be about 3×10⁻⁶ K⁻¹. Such thermal expansion mismatch may be a major source of failure of the piezoelectric device 108. The failure of piezoelectric device 108 may require a replacement of the patch sensor 100 from its host structure. As mentioned, the buffer layer 110 may be used to reduce the negative effect of the thermal coefficient mismatch between the piezoelectric layer 116 and the substrate 102.

The buffer layer 110 may be made of conductive polymer or metal, preferably aluminum (Al) with the thermal expansion coefficient of 2×10⁻⁵ K⁻¹. One or more buffer layers made of alumina, silicon or graphite may replace or be added to the buffer layer 110. In one embodiment, the thickness of the buffer layer 110 made of aluminum may be nearly equal to that of the piezoelectric layer 116, which is approximately 0.25 mm including the two conductive flakes 112 and 114 of about 0.05 mm each. In general, the thickness of the buffer layer 110 may be determined by the material property and thickness of its adjacent layers. The buffer layer 110 may provide an enhanced durability against thermal loads and consistency in the twofold function of the piezoelectric device 108. In an alternative embodiment, the piezoelectric device 108 may have another buffer layer applied over the top conductive flake 114.

Another function of the buffer layer 110 may be amplifying signals received by the substrate 102. As Lamb wave signals generated by a patch sensor 100 propagate along a host structure, the intensity of the signals received by another patch sensor 100 attached on the host structure may decrease as the distance between the two patch sensors increases. When a Lamb signal arrives at the location where a patch sensor 100 is located, the substrate 102 may receive the signal. Then, depending on the material and thickness of the buffer layer 110, the intensity of the received signal may be amplified at a specific frequency. Subsequently, the piezoelectric device 108 may convert the amplified signal into electrical signal.

As moisture, mobile ions and hostile environmental condition may degrade the performance and reduce the lifetime of the patch sensor 100, two protective coating layers, a molding layer 120 and a cover layer 106 may be used. The molding layer 120 may be made of epoxy, polyimide or silicone-polyimide by the normal dispensing method. Also, the molding layer 120 may be formed of a low thermal expansion polyimide and deposited over the piezoelectric device 108 and the substrate 102. As passivation of the molding layer 120 does not make a conformal hermetic seal, the cover layer 106 may be deposited on the molding layer 120 to provide a hermitic seal. The cover layer 120 may be made of metal, such as nickel (Ni), chromium (Cr) or silver (Ag), and deposited by a conventional method, such as electrolysis or e-beam evaporation and sputtering. In one embodiment, an additional film of epoxy or polyimide may be coated on the cover layer 106 to provide a protective layer against scratching and cracks.

The hoop layer 104 may be made of dielectric insulating material, such as silicon nitride or glass, and encircle the piezoelectric device 108 mounted on the substrate 102 to prevent the conductive components of the piezoelectric device 108 from electrical shorting.

FIG. 1C is a schematic top view of a piezoelectric device 130, which may be a conventional type known in the art and can be used in place of the piezoelectric device 108. FIG. 1D is a schematic cross-sectional view of the piezoelectric device 130 taken along the direction B-B of FIG. 1D. As shown FIGS. 1C-D, the piezoelectric device 130 includes: a bottom conductive flake 134; a piezoelectric layer 136; a top conductive flake 132 connected to a wire 138b; a connection flake 142 connected to a wire 138a; and a conducting segment 144 for connecting the connection flake 142 to the bottom flake 134. The top conductive flake 132 may be electrically separated from the connection flake 142 by a groove 140.

FIG. 1E is a schematic top cut-away view of a patch sensor 150 in accordance with another embodiment of the present teachings. FIG. 1F is a schematic side cross-sectional view of the patch sensor 150 shown in FIG. 1E. As shown in FIGS. 1E-F, the patch sensor 150 may include: a bottom substrate 151; a top substrate 152; a hoop layer 154; a piezoelectric device 156; top and bottom buffer layers 160a-b; two electrical wires 158a-b connected to the piezoelectric device 108. The piezoelectric device 156 includes: a piezoelectric layer 164; a bottom conductive flake 166 connected to the electrical wire 158b; and a top conductive flake 162 connected to the electrical wire 158a. The functions and materials for the components of the patch sensor 150 may be similar to those for their counterparts of the patch sensor 100. Each of the buffer layers 160a-b may include more than one sublayer and each sublayer may be composed of polymer or metal. The top substrate 152 may be made of the same material as that of the substrate 102.

The patch sensor 150 may be affixed to a host structure to monitor the structural health conditions. Also, the patch sensor 150 may be incorporated within a laminate. FIG. 1G is a schematic cross-sectional view of a composite laminate 170 having a patch sensor 150 therewithin. As illustrated in FIG. 1G, the host structure includes: a plurality of plies 172; and at least one patch sensor 150 cured with the plurality of plies 172. In one embodiment, the plies 172 may be impregnated with adhesive material, such as epoxy resin, prior to the curing process. During the curing process, the adhesive material from the plies 172 may fill cavities 174. To obviate such accumulation of the adhesive material, the hoop layer 154 may have a configuration to fill the cavity 174.

FIG. 1H is a schematic side cross-sectional view of an alternative embodiment 180 of the patch sensor 150 of FIG. 1E. As illustrated, the patch sensor 180 may include: a bottom substrate 182; a top substrate 184; a hoop layer 198; a piezoelectric device 190; top and bottom buffer layers 192 and 194; and the piezoelectric device 196. For simplicity, a pair of wires connected to the piezoelectric device 190 is not shown in FIG. 1H. The piezoelectric device 190 may include: a piezoelectric layer 196; a bottom conductive flake 194; and a top conductive flake 192. The functions and materials for the components of the patch sensor 180 may be similar to those of their counterparts of the patch sensor 150.

The hoop layer 198 may have one or more sublayers 197 of different dimensions so that the outer contour of the hoop layer 198 may match the geometry of cavity 174. By filling the cavity 174 with sublayers 197, the adhesive material may not be accumulated during the curing process of the laminate 170.

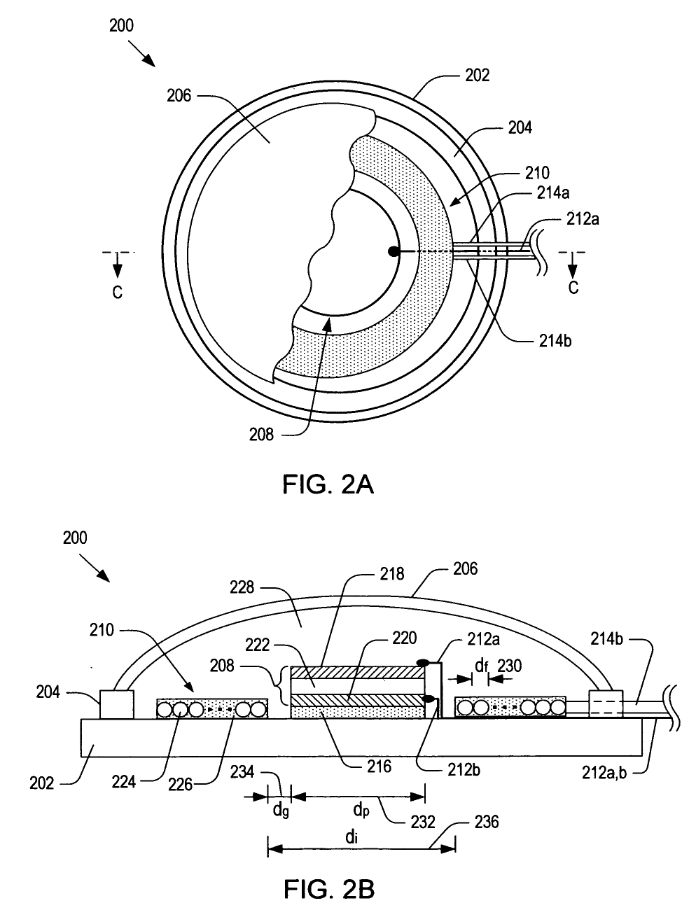

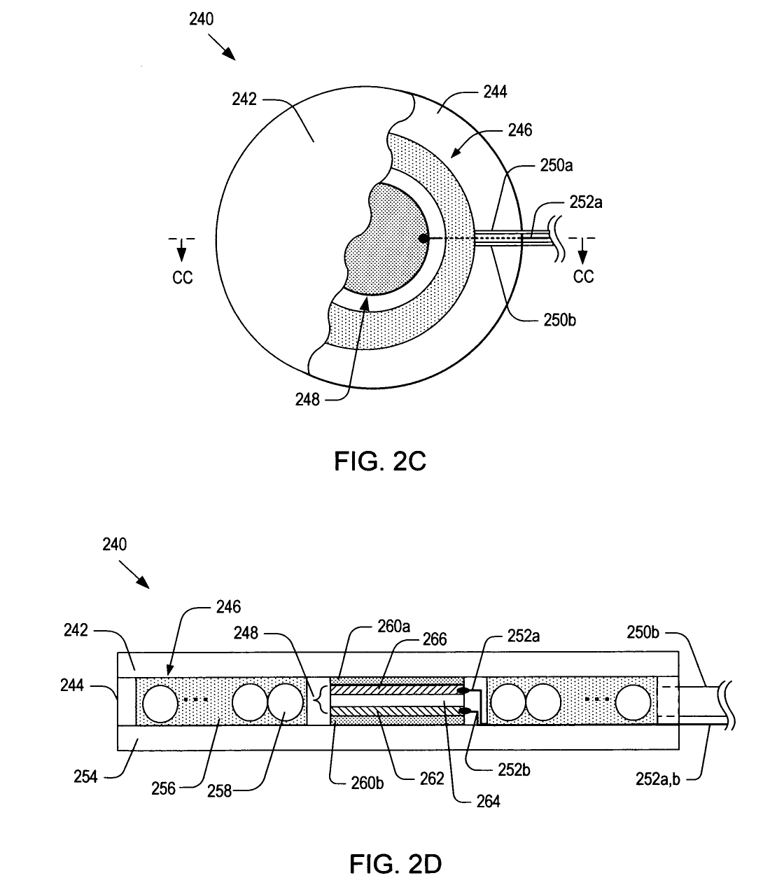

FIG. 2A is a schematic top cut-away view of a pickup unit 200 of a hybrid patch sensor in accordance with one embodiment of the present teachings. Hereinafter, the terms “pickup unit of a hybrid patch sensor” and “hybrid patch sensor” are used interchangeably. FIG. 2B is a schematic cross-sectional view of the hybrid patch sensor 200 taken along a direction C-C of FIG. 2A. As shown in FIGS. 2A-B, the hybrid patch sensor 200 may include: a substrate 202 configured to attach to a host structure; a hoop layer 204; a piezoelectric device 208; an optical fiber coil 210 having two ends 214a-b; a buffer layer 216; two electrical wires 212a-b connected to the piezoelectric device 208; a molding layer 228; and a cover layer 206. The piezoelectric device 208 includes: a piezoelectric layer 222; a bottom conductive flake 220 connected to the electrical wire 212b; and a top conductive flake 218 connected to the electrical wire 212a. In an alternative embodiment, the piezoelectric device 208 may be the same as the device 130 of FIG. 1C. The optical fiber coil 210 may include; a rolled optical fiber cable 224; and a coating layer 226. Components of the hybrid patch sensor 200 may be similar to their counterparts of the patch sensor 100.

The optical fiber coil 210 may be a Sagnac interferometer and operate to receive Lamb wave signals. The elastic strain on the surface of a host structure incurred by Lamb wave may be superimposed on the preexisting strain of the optical fiber cable 224 incurred by bending and tensioning. As a consequence, the amount of frequency/phase change in light traveling through the optical fiber cable 224 may be dependent on the total length of the optical fiber cable 224. In one embodiment, considering its good immunity to electromagnetic interference and vibrational noise, the optical fiber coil 210 may be used as the major sensor while the piezoelectric device 208 can be used as an auxiliary sensor.

The optical fiber coil 210 exploits the principle of Doppler's effect on the frequency of light traveling through the rolled optical fiber cable 224. For each loop of the optical fiber coil 210, the inner side of the optical fiber loop may be under compression while the outer side may be under tension. These compression and tension may generate strain on the optical fiber cable 224. The vibrational displacement or strain of the host structure incurred by Lamb waves may be superimposed on the strain of the optical fiber cable 224. According to a birefringence equation, the reflection angle on the cladding surface of the optical fiber cable 224 may be a function of the strain incurred by the compression and/or tension. Thus, the inner and outer side of each optical fiber loop may make reflection angles different from that of a straight optical fiber, and consequently, the frequency of light may shift from a centered input frequency according to the relative flexural displacement of Lamb wave as light transmits through the optical fiber coil 210.

In one embodiment, the optical fiber coil 210 may include 10 to 30 turns of the optical fiber cable 224 and have a smallest loop diameter 236, dᵢ, of at least 10 mm. There may be a gap 234, d_{g}, between the innermost loop of the optical fiber coil 210 and the outer periphery of the piezoelectric device 208. The gap 234 may depend on the smallest loop diameter 236 and the diameter 232, dₚ, of the piezoelectric device 208, and be preferably larger than the diameter 232 by about two or three times of the diameter 230, d_{f}, of the optical fiber cable 224.

The coating layer 226 may be comprised of a metallic or polymer material, preferably an epoxy, to increase the sensitivity of the optical fiber coil 210 to the flexural displacement or strain of Lamb waves guided by its host structure. Furthermore, a controlled tensional force can be applied to the optical fiber cable 224 during the rolling process of the optical fiber cable 224 to give additional tensional stress. The coating layer 226 may sustain the internal stress of the rolled optical fiber cable 224 and allow a uniform in-plane displacement relative to the flexural displacement of Lamb wave for each optical loop.

The coating layer 226 may also be comprised of other material, such as polyimide, aluminum, copper, gold or silver. The thickness of the coating layer 226 may range from about 30% to two times of the diameter 230. The coating layer 226 comprised of polymer material may be applied in two ways. In one embodiment, a rolled optic fiber cable 224 may be laid on the substrate 202 and the polymer coating material may be sprayed by a dispenser, such as Biodot spay-coater. In another embodiment, a rolled optic fiber cable 224 may be dipped into a molten bath of the coating material.

Coating layer 226 comprised of metal may be applied by a conventional metallic coating technique, such as magnetron reactive or plasma-assisted sputtering as well as electrolysis. Specially, the zinc oxide can be used as the coating material of the coating layer 226 to provide the piezoelectric characteristic for the coating layer 226. When zinc oxide is applied to top and bottom surfaces of the rolled optical fiber cable 224, the optical fiber coil 210 may contract or expand concentrically in radial direction responding to electrical signals. Furthermore, the coating material of silicon oxide or tantalum oxide can also be used to control the refractive index of the rolled fiber optical cable 224. Silicon oxide or tantalum oxide may be applied using the indirect/direct ion beam-assisted deposition technique or electron beam vapor deposition technique. It is noted that other methods may be used for applying the coating layer 226 to the optical fiber cable 224 without deviating from the present teachings.

The piezoelectric device 208 and the optical fiber coil 210 may be affixed to the substrate 202 using physically setting adhesives instead of common polymers, where the physically setting adhesives may include, but not limited to, butylacrylate-ethylacrylate copolymer, styrene-butadiene-isoprene terpolymer and polyurethane alkyd resin. The adhesive properties of these materials may remain constant during and after the coating process due to the lack of cross-linking in the polymeric structure. Furthermore, those adhesives may be optimized for wetting a wide range of substrate 202 without compromising their sensitivity to different analytes, compared to conventional polymers.

FIG. 2C is a schematic top cut-away view of a hybrid patch sensor 240 in accordance with another embodiment of the present teachings. FIG. 2D is a schematic side cross-sectional view of the hybrid patch sensor 240 shown in FIG. 2C. As shown in FIGS. 2C-D, the hybrid patch sensor 240 may include: a bottom substrate 254; a top substrate 242; a hoop layer 244; a piezoelectric device 248; an optical fiber coil 246 having two ends 250a-b; top and bottom buffer layers 260a-b; and two electrical wires 252a-b connected to the piezoelectric device 248. The piezoelectric device 248 includes: a piezoelectric layer 264; a bottom conductive flake 262 connected to the electrical wire 252b; and a top conductive flake 266 connected to the electrical wire 252a. The optical fiber coil 246 may include; a rolled optical fiber cable 258; and a coating layer 256. Components of the hybrid patch sensor 240 may be similar to their counterparts of the hybrid patch sensor 200.

As in the case of the patch sensor 150, the hybrid patch sensor 240 may be affixed to a host structure and/or incorporated within a composite laminate. In one embodiment, the hoop layer 244 may be similar to the hoop layer 198 to fill the cavity formed by the patch sensor 240 and the composite laminate.

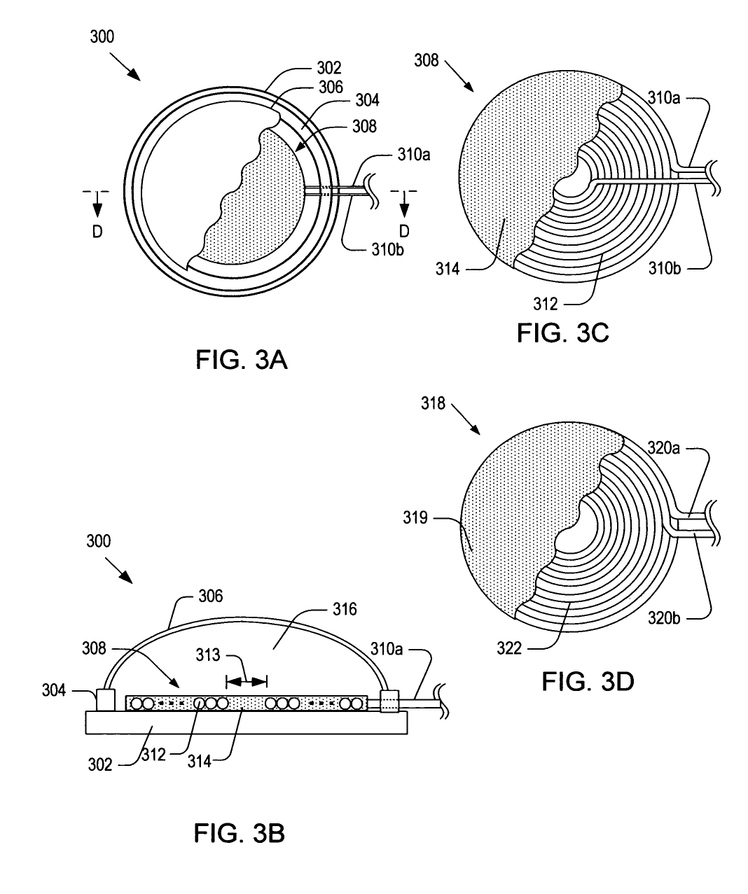

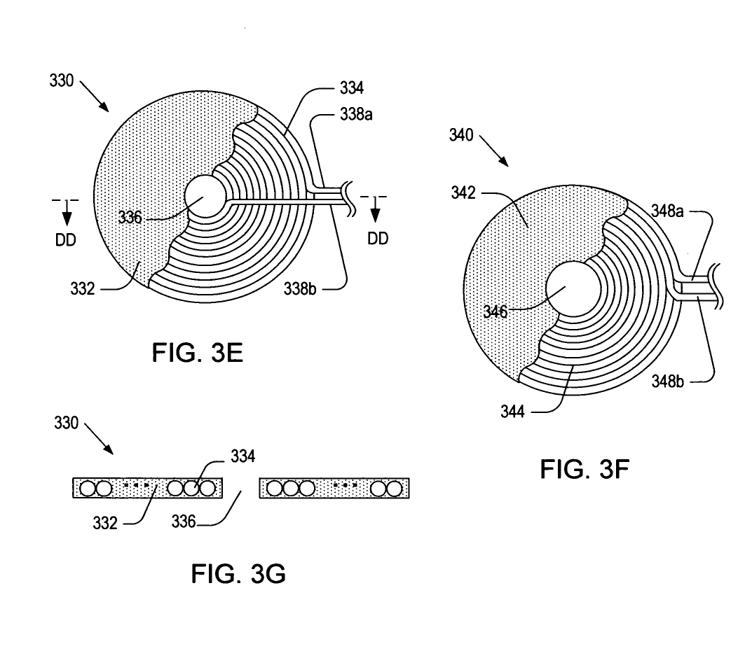

FIG. 3A a schematic top cut-away view of a pickup unit 300 of an optical fiber patch sensor in accordance with one embodiment of the present teachings. Hereinafter, the terms “pickup unit of an optical fiber patch sensor” and “optical fiber patch sensor” are used interchangeably. FIG. 3B a schematic side cross-sectional view of the optical fiber patch sensor 300 taken along the direction D-D of FIG. 3A. As shown in FIGS. 3A-B, the optical fiber patch sensor 300 may include: a substrate 302; a hoop layer 304; an optical fiber coil 308 having two ends 310a-b; a molding layer 316; and a cover layer 306. The optical fiber coil 308 may include; a rolled optical fiber cable 312; and a coating layer 314. The material and function of each element of the optical fiber patch sensor 300 may be similar to those of its counterpart of the hybrid patch sensor 200 in FIG. 2A. The diameter 313 of the innermost loop may be determined by the material property of the optic fiber cable 312.

FIG. 3C a schematic top cut-away view of the optical fiber coil 308 contained in the optical fiber patch sensor of FIG. 3A, illustrating a method for rolling the optical fiber cable 312. As shown in FIG. 3C, the outermost loop of the optical fiber coil 308 may start with one end 310a while the innermost loop may end with the other end 310b. FIG. 3D a schematic top cut-away view of an alternative embodiment 318 of the optical fiber coil 308 shown in FIG. 3C. As shown in FIG. 3D, the optical fiber cable 322 may be folded and rolled in such a manner that the outermost loops may start with both ends 320a-b. The rolled optical fiber cable 322 may be covered by a coating layer 319.

It is noted that the optical fiber coils 308 and 318 show in FIGS. 3C-D may be attached directly to a host structure and used as optical fiber coil sensors. For this reason, hereinafter, the terms “optical fiber coil” and “optical fiber coil sensor” will be used interchangeably. FIGS. 3E-F are alternative embodiments of the optical fiber coil 308. As illustrated in FIG. 3E, the optical fiber coil 330 may include: an optical fiber cable 334 having two ends 338a-b and being rolled in the same manner as the cable 312; and a coating layer 332. The coil 330 may have a hole 336 to accommodate a fastener as will be explained later. Likewise, the optical fiber coil 340 in FIG. 3F may include: an optical fiber cable 344 having two ends 348a-b and being rolled in the same manner as the cable 322; and a coating layer 342. The coil 340 may have a hole 346 to accommodate a fastener. FIG. 3G is a schematic side cross-sectional view of the optical fiber coil 330 taken along the direction DD of FIG. 3E.

It should be noted that the sensors described in FIG. 3A-G may be incorporated within a laminate in a similar manner as described in FIG. 1G.

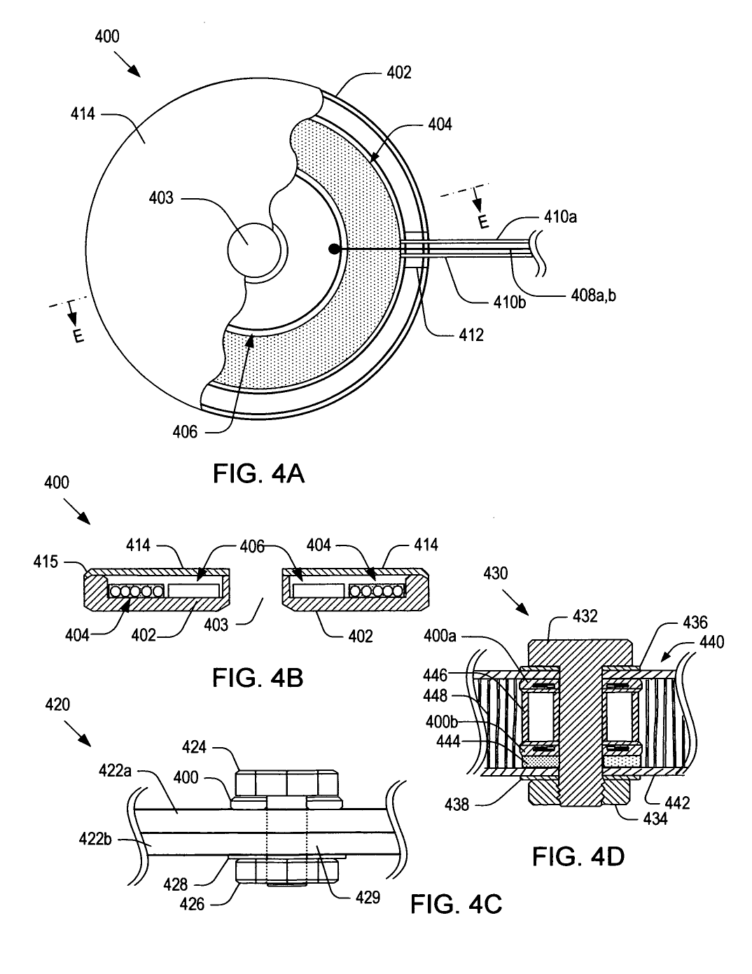

FIG. 4A a schematic top cut-away view of a pickup unit 400 of a diagnostic patch washer in accordance with one embodiment of the present teachings. Hereinafter, the terms “pickup unit of a diagnostic patch washer” and “diagnostic patch washer” are used interchangeably. FIG. 4B a schematic side cross-sectional view of the diagnostic patch washer 400 taken along the direction E-E of FIG. 4A. As shown in FIGS. 4A-B, the diagnostic patch washer 400 may include: an optical fiber coil 404 having two ends 410a-b; a piezoelectric device 406; a support element 402 for containing the optical fiber coil 404 and the piezoelectric device 406, the coil 404 and the device 406 being affixed to the support element 402 by adhesive material; a pair of electrical wires 408a-b connected to the piezoelectric device 406; and a covering disk 414 configured to cover the optical fiber coil 404 and the piezoelectric device 406. The optical fiber coil 404 and piezoelectric device 406 may be include within a space or channel formed in the support element 402.

The material and function of the optical fiber coil 404 and the piezoelectric device 406 may be similar to those of the optical fiber coil 210 and the piezoelectric device 208 of the hybrid patch sensor 200. In one embodiment, the piezoelectric device 406 may be similar to the device 130, except that the device 406 has a hole 403. The optical fiber coil 404 and the piezoelectric device 406 may be affixed to the support element 402 using a conventional epoxy. The support element 402 may have a notch 412, through which the ends 410a-b of the optical fiber coil 404 and the pair of electrical wires 408a-b may pass.

In FIGS. 4A-B, the diagnostic patch washer 400 may operate as an actuator/sensor and have the optical fiber coil 404 and the piezoelectric device 406. In an alternative embodiment, the diagnostic patch washer 400 may operate as a sensor and have the optical fiber coil 404 only. In another alternative embodiment, the diagnostic patch washer 400 may operate as an actuator/sensor and have the piezoelectric device 406 only.

As shown in FIGS. 4A-B, the diagnostic patch washer 400 may have a hollow space 403 to accommodate other fastening device, such as a bolt or rivet. FIG. 4C is a schematic diagram of an exemplary bolt-jointed structure 420 using the diagnostic patch washer 400 in accordance with one embodiment of the present teachings. In the bolt-jointed structure 420, a conventional bolt 424, nut 426 and washer 428 may be used to hold a pair of structures 422a-b, such as plates. It is well known that structural stress may be concentrated near a bolt-jointed area 429 and prone to structural damages. The diagnostic patch washer 400 may be incorporated in the bolt-joint structure 420 and used to detect such damages.

FIG. 4D is a schematic cross-sectional diagram of an exemplary bolt-jointed structure 430 using the diagnostic patch washer 400 in accordance with another embodiment of the present teachings. In the bolt-joint structure 430, a conventional bolt 432, nut 434 and a pair of washers 436 and 438 may be used to hold a honeycomb/laminated structure 440. The honeycomb and laminate structure 440 may include a composite laminate layer 422 and a honeycomb portion 448. To detect the structural damages near the bolt-joint area, a pair of diagnostic patch washers 400a-b may be inserted within the honeycomb portion 448, as illustrated in FIG. 4D. A sleeve 446 may be required to support the top and bottom patch washers 400a-b against the composite laminate layer 442. Also, a thermal-protection circular disk 444 may be inserted between the composite laminate layer 422 and the diagnostic patch washer 400b to protect the washer 400b from destructive heat transfer.

As shown in FIG. 4B, the outer perimeter 415 of the covering disk 414 may have a slant angle to form a locking mechanism, which can keep optical fiber coil 404 and the piezoelectric device 406 from excessive contact load by the torque applied to the bolt 424 and nut 426.

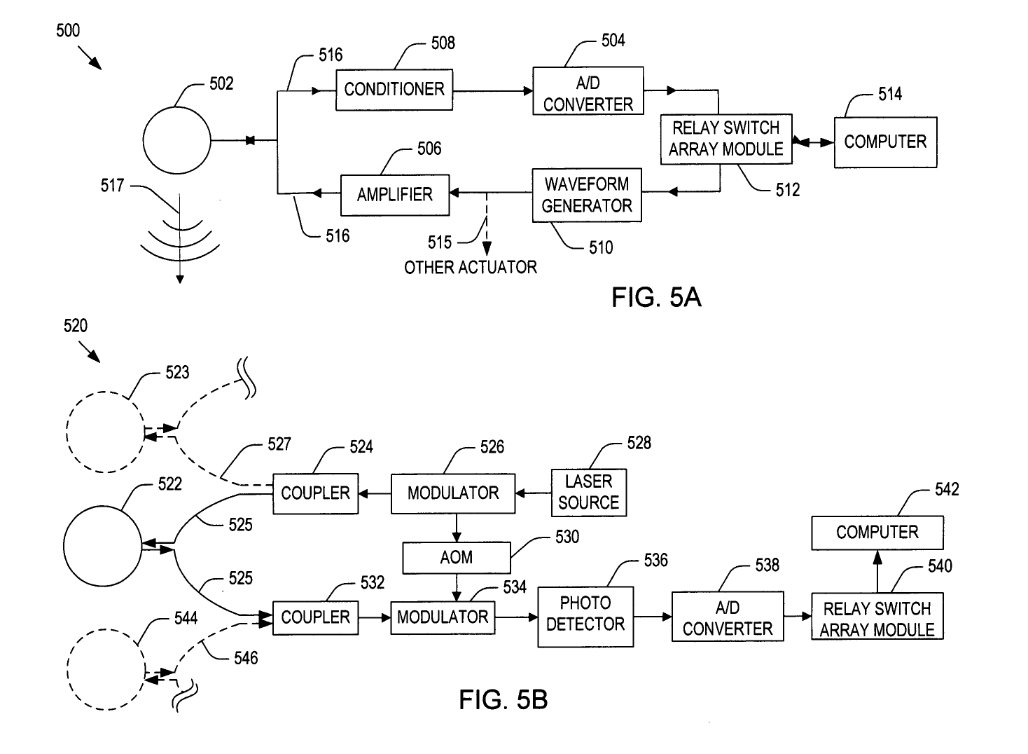

FIG. 5A is a schematic diagram of an interrogation system 500 including a sensor/actuator device in accordance with one embodiment of the present teachings. Hereinafter, the terms “sensor” and “pickup unit of a sensor” are interchangeably used. As shown in FIG. 5A, the system 500 may include: a sensor/actuator device 502 for generating and/or receiving Lamb wave signals; a two-conductor electrical wire 516; a conditioner 508 for processing signals received by the device 502; analog-to-digital (A/D) converter 504 for converting analog signals to digital signals; a computer 514 for managing entire elements of the system 500; an amplifier 506; a waveform generator 510 for converting digital signals into the analog Lamb wave signals; and a relay switch array module 512 configured to switch connections between the device 502 and the computer 514. In general, more than one device 502 may be connected to the relay switch 512.

The device 502 may be one of the sensors described in FIGS. 1A-2D and FIGS. 4A-D that may include a piezoelectric device for generating Lamb waves 517 and receiving Lamb waves generated by other devices. To generate Lamb waves 517, a waveform generator 510 may receive the digital signals of the excitation waveforms from computer 514 (more specifically, an analog output card included in the computer 514) through the relay switch array module 512. In one embodiment, the waveform generator 510 may be an analog output card.

The relay switch array module 512 may be a conventional plug-in relay board. As a “cross-talks” linker between the actuators and sensors, the relay switches included in the relay switch array module 512 may be coordinated by the microprocessor of the computer 514 to select each relay switch in a specific sequencing order. In one embodiment, analog signals generated by the waveform generator 510 may be sent to other actuator(s) through a branching electric wire 515.

The device 502 may function as a sensor for receiving Lamb waves. The received signals may be sent to the conditioner 508 that may adjust the signal voltage and filter electrical noise to select meaningful signals within an appropriate frequency bandwidth. Then, the filtered signal may be sent to the analog-to-digital converter 504, which may be a digital input card. The digital signals from the analog-to-digital converter 504 may be transmitted through the relay switch array module 512 to the computer 514 for further analysis.

FIG. 5B is a schematic diagram of an interrogation system 520 including a sensor in accordance with another embodiment of the present teachings. The system 520 may include: a sensor 522 having an optical fiber coil; optical fiber cable 525 for connections; a laser source 528 for providing a carrier input signal; a pair of modulators 526 and 534; an acoustical optic modulator (AOM) 530; a pair of coupler 524 and 532; a photo detector 536 for sensing the light signal transmitted through the optical fiber cable 525; an A/D converter 538; a relay switch 540; and a computer 542. The sensor 522 may be one of the sensors described in FIGS. 2A4D that may include an optical fiber coil. In one embodiment, the coupler 524 may couple the optical fiber cable 525 to another optical fiber 527 that may be connected to another sensor 523.

The sensor 522, more specifically the optic fiber coil included in the sensor 522, may operate as a laser Doppler velocitimeter (LDV). The laser source 528, preferably a diode laser, may emit an input carrier light signal to the modulator 526. The modulator 526 may be a heterodyne modulator and split the carrier input signal into two signals; one for the sensor 522 and the other for AOM 530. The sensor 522 may shift the input carrier signal by a Doppler's frequency corresponding to Lamb wave signals and transmit it to the modulator 534, where the modulator 534 may be a heterodyne synchronizer. The modulator 534 may demodulate the transmitted light to remove the carrier frequency of light. The photo detector 536, preferably a photo diode, may convert the demodulated light signal into an electrical signal. Then, the A/D converter 538 may digitize the electrical signal and transmit to the computer 542 via the relay switch array module 540. In one embodiment, the coupler 532 may couple an optical fiber cable 546 connected to another sensor 544.

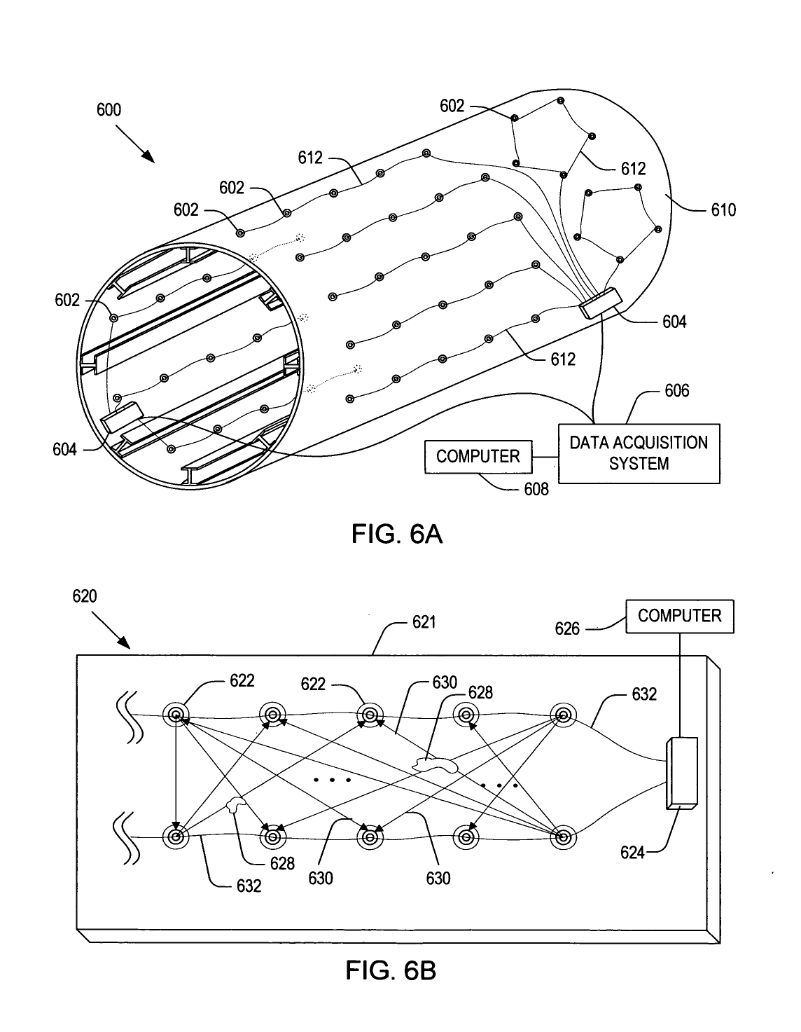

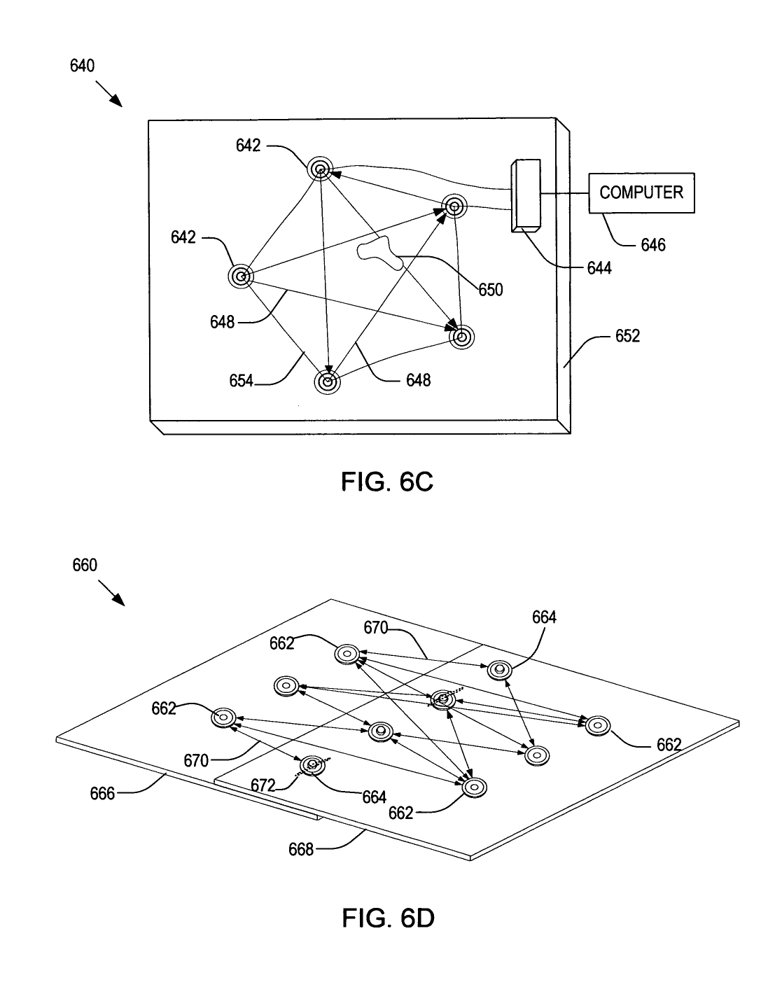

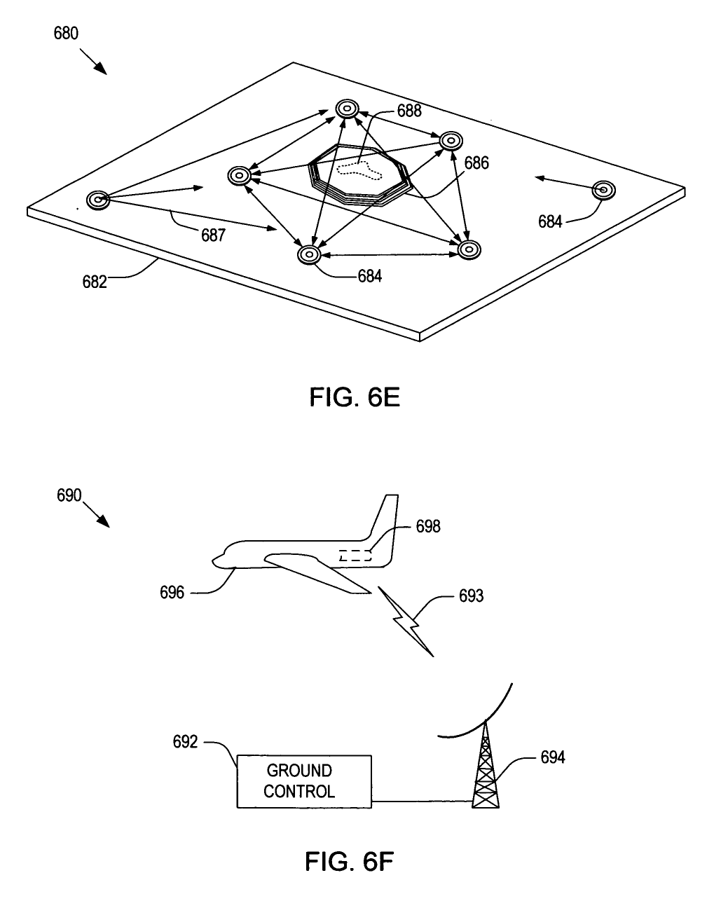

FIG. 6A is a schematic diagram of a diagnostic network patch system (DNP) 600 applied to a host structure 610 in accordance with one embodiment of the present teachings. As illustrated in FIG. 6A, the system 600 may include: patches 602; transmission links 612; at least one bridge box 604 connected to the transmission links 612; a data acquisition system 606; and a computer 608 for managing the DNP system 600. The patches 602 may be a device 502 or a sensor 522, where the type of transmission links 612 may be determined by the type of the patches 602 and include electrical wires, optical fiber cables, or both. Typically, the host structure 610 may be made of composite or metallic material.

Transmission links 612 may be terminated at the bridge box 604. The bridge box 604 may connect the patches 602 to admit signals from an external waveform generator 510 and to send received signals to an external A/D converter 504. The bridge box 604 may be connected through an electrical/optical cable and can contain an electronic conditioner 508 for conditioning actuating signals, filtering received signals, and converting fiber optic signals to electrical signals. Using the relay switch array module 512, the data acquisition system 606 coupled to the bridge box 604 can relay the patches 602 and multiplex received signals from the patches 602 into the channels in a predetermined sequence order.

It is well known that the generation and detection of Lamb waves is influenced by the locations of actuators and sensors on a host structure. Thus, the patches 602 should be properly paired in a network configuration to maximize the usage of Lamb waves for damage identification.

FIG. 6B is a schematic diagram of a diagnostic network patch system 620 having a strip network configuration in accordance with one embodiment of the present teachings. As shown in FIG. 6B, the system 620 may be applied to a host structure 621 and include: patches 622; a bridge box 624 connected to a computer 626; and transmission links 632. The patches 622 may be a device 502 or a sensor 522, where the type of transmission links 632 may be determined by the type of the patches 622. The transmission links 632 may be electrical wires, optical fiber cables, or both.

The computer 626 may coordinate the operation of patches 622 such that they may function as actuators and/or sensors. Arrows 630 represent the propagation of Lamb waves generated by patches 622. In general, defects 628 in the host structure 621 may affect the transmission pattern in the terms of wave scattering, diffraction, and transmission loss of Lamb waves. The defects 628 may include damages, crack and delamination of composite structures, etc. The defects 628 may be monitored by detecting the changes in transmission pattern of Lamb waves captured by the patches 622.

The network configuration of DNP system is important in Lamb-wave based structural health monitoring systems. In the network configuration of DNP system 620, the wave-ray communication paths should be uniformly randomized. Uniformity of the communication paths and distance between the patches 622 can determine the smallest detectible size of defects 628 in the host structure 621. An optimized network configuration with appropriate patch arrangement may enhance the accuracy of the damage identification without increasing the number of the patches 622.

Another configuration for building up wave ‘cross-talk’ paths between patches may be a pentagonal network as shown in FIG. 6C. FIG. 6C is a schematic diagram of a diagnostic network patch system 640 having a pentagon network configuration in accordance with another embodiment of the present teachings. The system 640 may be applied to a host structure 652 and may include: patches 642; a bridge box 644 connected to a computer 646; and transmission links 654. The patches 642 may be a device 502 or a sensor 522. As in the system 630, the patches 642 may detect a defect 650 by sending or receiving Lamb waves indicated by the arrows 648.

FIG. 6D is a schematic perspective view of a diagnostic network patch system 660 incorporated into rivet/bolt-jointed composite laminates 666 and 668 in accordance with another embodiment of the present teachings. As illustrated in FIG. 6D, the system 660 may include: patches 662; and diagnostic patch washers 664, each washer being coupled with a pair of bolt and nut. For simplicity, a bridge box and transmission links are not shown in FIG. 6D. The patches 662 may be a device 502 or a sensor 522. In the system 660, the patches 662 and diagnostic patch washers 664 may detect the defects 672 by sending or receiving Lamb waves as indicated by arrows 670. Typically, the defects 672 may develop near the holes for the fasteners. The diagnostic patch washers 664 may communicate with other neighborhood diagnostic patches 662 that may be arranged in a strip network configuration, as shown in FIG. 6D. In one embodiment, the optical fiber coil sensors 330 and 340 may be used in place of the diagnostic patch washers 664.

FIG. 6E is a schematic perspective view of a diagnostic network patch system 680 applied to a composite laminate 682 that may be repaired with a bonding patch 686 in accordance with one embodiment of the present teachings. As illustrated in FIG. 6E, the system 680 may include patches 684 that may be a device 502 or a sensor 522. For simplicity, a bridge box and transmission links are not shown in FIG. 6E. In the system 680, the patches 684 may detect the defects 688 located between the repair patch 686 and the composite laminate 682 by sending or receiving Lamb waves as indicated by arrows 687.

FIG. 6F is a schematic diagram illustrating an embodiment of a wireless data communication system 690 that controls a remote diagnostic network patch system in accordance with one embodiment of the present teachings. As illustrated in FIG. 6F, the system 690 includes: a bridge box 698; and a ground communication system 694 that may be operated by a ground control 692. The bridge box 698 may be coupled to a diagnostic network patch system implemented to a host structure, such as an airplane 696, that may require extensive structural health monitoring.

The bridge box 698 may operate in two ways. In one embodiment, the bridge box 698 may operate as a signal emitter. In this embodiment, the bridge box 698 may comprise micro miniature transducers and a microprocessor of a RF telemetry system that may send the structural health monitoring information to the ground communication system 694 via wireless signals 693. In another embodiment, the bridge box 698 may operate as a receiver of electromagnetic waves. In this embodiment, the bridge box 698 may comprise an assembly for receiving power from the ground communication system 694 via wireless signals 693, where the received power may be used to operate a DNP system applied to the structure 696. The assembly may include a micro-machined silicon substrate that has stimulating electrodes, complementary metal oxide semiconductor (CMOS), bipolar power regulation circuitry, hybrid chip capacitors, and receiving antenna coils.

The structure of the bridge box 698 may be similar to the outer layer of the host structure 696. In one embodiment, the bridge box 698 may have a multilayered honeycomb sandwich structure, where a plurality of micro strip antennas are embedded in the outer faceplate of the multilayered honeycomb sandwich structure and operate as conformal load-bearing antennas. The multilayered honeycomb sandwich structure may comprise a honeycomb core and multilayer dielectric laminates made of organic and/or inorganic materials, such as e-glass/epoxy, Keviar/epoxy, graphite/epoxy, aluminum or steel. As the integrated micro-machining technology evolves rapidly, the size and production cost of the micro strip antennas may be reduced further, which may translate to savings of operational/production costs of the bridge box 698 without compromising its performance.

The scope of the invention is not intended to limit to the use of the standard Wireless Application Protocol (WAP) and the wireless markup languages for a wireless structural health monitoring system. With a mobile Internet toolkit, the application system can build a secure site to which structural condition monitoring or infrastructure management can be correctly accessed by a WAP-enable cell phone, a Pocket PC with a HTML browser, or other HTML-enabled devices.

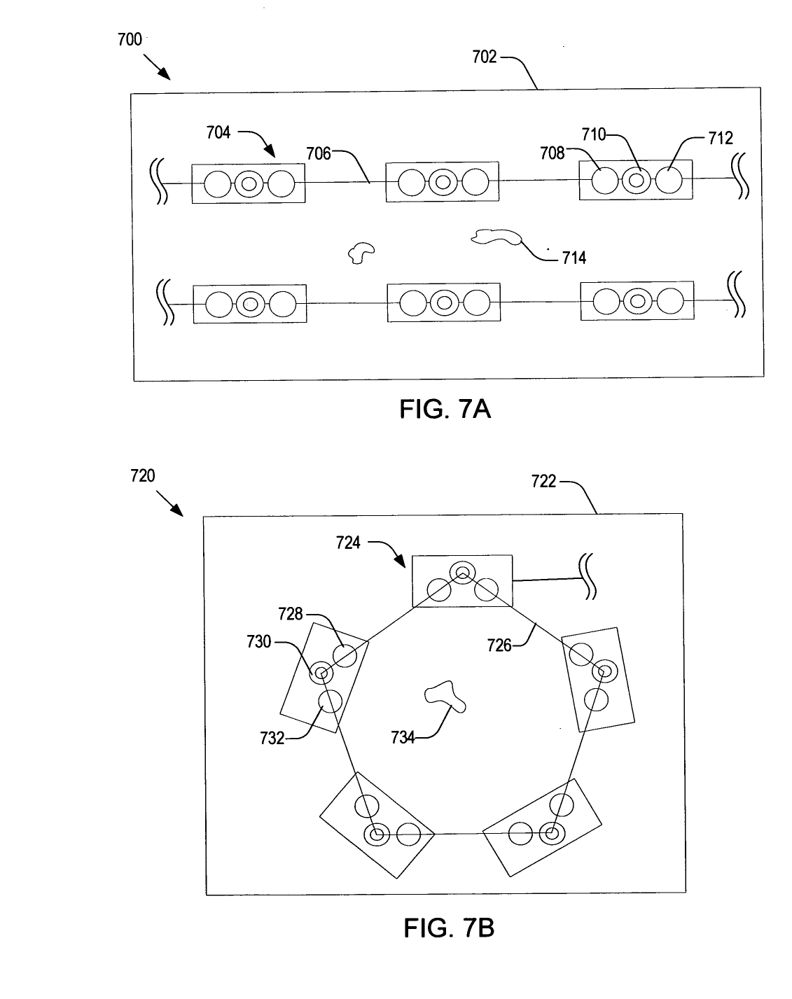

As a microphone array may be used to find the direction of a moving source, a clustered sensor array may be used to find damaged locations by measuring the difference in time of signal arrivals. FIG. 7A is a schematic diagram of a diagnostic network patch system 700 having clustered sensors in a strip network configuration in accordance with one embodiment of the present teachings. As illustrated in FIG. 7A, the system 700 may be applied to a host structure 702 and include clustered sensors 704 and transmission links 706. Each clustered sensor 704 includes two receivers 708 and 712 and one actuator/receiver device 710. Each of the receivers 708 and 712 may be one of the sensors described in FIGS. 1A-4D, while the actuator/receiver device 710 may be one of the sensors described in FIGS. 1A-2D and FIGS. 4A-D and have a piezoelectric device for generating Lamb waves. When the actuator/receiver 710 of a clustered sensor 704 sends Lamb waves, the neighboring clustered sensors 704 may receive the Lamb waves using all three elements, i.e., the actuator/receiver device 710 and receivers 708 and 712. By using all three elements as a receiver unit, each clustered sensor 704 can receive more refined Lamb wave signals. Also, by measuring the difference in time of arrivals between the three elements, the direction of the defect 714 may be located with enhanced accuracy.

FIG. 7B is a schematic diagram of a diagnostic network patch system 720 having clustered sensors in a pentagonal network configuration in accordance with another embodiment of the present teachings. As illustrated in FIG. 7B, the system 720 may be applied to a host structure 722 to detect a defect 734 and include clustered sensors 724 and transmission links 726. Each clustered sensor 724 may be similar to the clustered sensor 704.

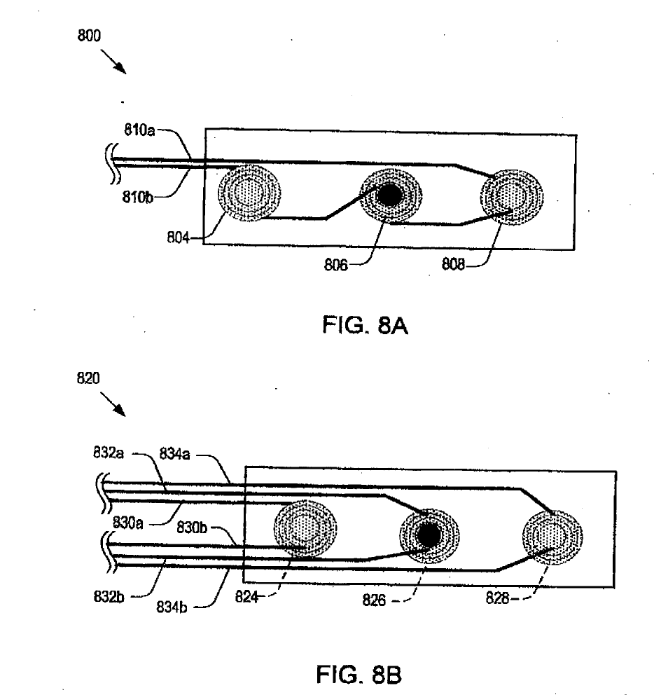

FIG. 8A shows a schematic diagram of a clustered sensor 800 having optical fiber coils in a serial connection in accordance with one embodiment of the present teachings. The clustered sensor 800 may be similar to the clustered sensor 704 in FIG. 7A and include two sensors 804 and 808 and an actuator/sensor 806. In this configuration, an input signal may enter the sensor through one end 810a and the output signal from the other end 810b may be a sum of the input signal and contribution of the three sensors 804, 806 and 808. In one embodiment, the signal from each sensor may be separated from others using a wavelength-based de-multiplex techniques.

FIG. 8B a schematic diagram of a clustered sensor 820 having optical fiber coils in a parallel connection in accordance with one embodiment of the present teachings. The clustered sensor 820 may be similar to the clustered sensor 704 in FIG. 7A and include two sensors 824 and 828 and an actuator/sensor 826. In this configuration, input signals may enter the three sensors through three end 830a, 832a and 834a, respectively, while output signals from the other ends 830b, 832b and 834b may be a sum of the input signal and contribution of the three sensors 824, 826 and 828, respectively.

It is noted that, in FIGS. 8A-B, the sensors 804, 808, 824 and 828 have been illustrated as optical fiber coil sensors 308. However, it should apparent to those of ordinary skill in the art that each of the sensors 804, 808, 824 and 828 may be one of the sensors described in FIGS. 1A-4D, while each of the middle sensors 806 and 826 may be one of the sensors described in 1A-2D and FIGS. 4A-D and have a piezoelectric device for generating Lamb waves. Also, the clustered sensors 800 and 820 may be incorporated within a composite laminate in the same manner as described in FIG. 1G.

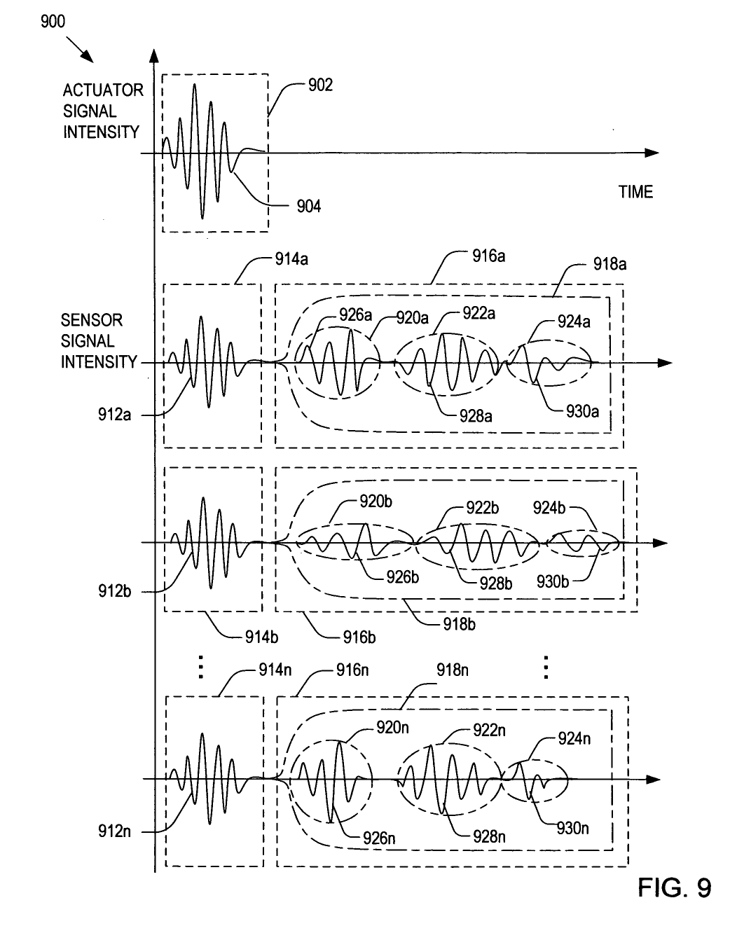

FIG. 9 shows a plot 900 of actuator and sensor signals in accordance with one embodiment of the present teachings. To generate Lamb waves, an actuator signal 904 may be applied to an actuator, such as a patch sensor 100. The actuator signal 904 may be a toneburst signal that has several wave peaks with the highest amplitude in the mid of waveform and has a spectrum energy of narrow frequency bandwidth. The actuator signal 904 may be designed by the use of Hanning function on various waveforms and have its central frequency within 0.01 MHz to 1.0 MHz. When the actuator receives the actuator signal 904, it may generate Lamb waves having a specific excitation frequency.

Signals 912a-n may represent sensor signals received by sensors. As can be noticed, each signal 912 may have wave packets 926, 928 and 930 separated by signal extracting windows (or, equivalently envelops) 920, 922 and 924, respectively. These wave packets 926, 928 and 930 may have different frequencies due to the dispersion modes at the sensor location. It is noted that the signal partitioning windows 916 have been applied to identify Lamb-wave signal from each sensor signal. The wave packets 926, 928 and 930 correspond to a fundamental symmetric mode S₀, a reflected mode S₀_{_{—}}_{ref} and a fundamental asymmetric mode A₀, respectively. The reflected mode S₀_{_{—}}_{ref} may represent the reflection of Lamb waves from a host structure boundary. A basic shear mode, S₀′, and other higher modes can be observed. However, they are not shown in FIG. 9 for simplicity.

Portions 914 of sensor signals 912 may be electrical noise due to the toneburst actuator signal 904. To separate the portions 914 from the rest of sensor signals 912, masking windows 916, which may be a sigmoid function delayed in the time period of actuation, may be applied to sensor signals 912 as threshold functions. Then, moving wave-envelope windows 920, 922 and 924 along the time history of each sensor signal may be employed to extract the wave packets 926, 928 and 930 from the sensor signal of 912. The envelope windows 920, 922 and 924 may be determined by applying a hill-climbing algorithm that searches for peaks and valleys of the sensor signals 912 and interpolating the searched data point in time axis. The magnitude and position of each data point in the wave signal may be stored if the magnitude of the closest neighborhood data points are less than that of the current data point until the comparison of wave magnitude in the forward and backward direction continues to all the data points of the wave signal. Once wave envelopes 918 are obtained, each envelope may break into sub envelope windows 920, 922 and 924 with time spans corresponding to those of Lamb-wave modes. The sub envelop windows 920, 922 and 924 may be applied to extract wave packets 926, 928 and 930 by moving along the entire time history of each measured sensor signal 912.

The bridge boxes 604 (FIG. 6A), 624 (FIG. 6B), 644 (FIG. 6C), and 698 (FIG. 6F) are disposed outside or inside the host structures and include in-situ measurement modules. As discussed above, the bridge boxes can send signals to active (PZT) DNP sensors to generate diagnostic waves, such as acousto-ultrasonic or Lamb wave, and get sensor signals received by active/passive DNP sensors working as active/passive structural neural system (SNS) sensors. Hereinafter, an active DNP sensor (or, shortly, active sensor) refers to, but not is limited to, a nondestructive inspection sensor, such as electromagnetic acoustic transducer (EMAT) and magnetostrictive sensor, an active SNS sensor that can send or receive an ultrasonic, optical, electromagnetic, laser or X-ray signal. An active sensor can generate a diagnostic wave and/or receive a diagnostic wave generated by another active sensor. The passive DNP sensor (or, shortly, passive sensor) includes, but is not limited to, a passive SNS sensor such as piezo and electrical conductive paint sensor, acoustic emission sensor, fiber-Bragg-grating strain sensor, optical fiber sensor, vibration sensor, displacement sensor, pressure transducer, thermometer, hygrometer, torque meter, tachometer, or gas detector. The sensors described in FIGS. 1A-2D and 4A-4D may operate as active or passive DNP sensors. More information of the sensor and system can be found in U.S. Pat. Nos. 7,117,742, 7,246,521, and 7,322,244, which are herein incorporated by reference in their entirety.

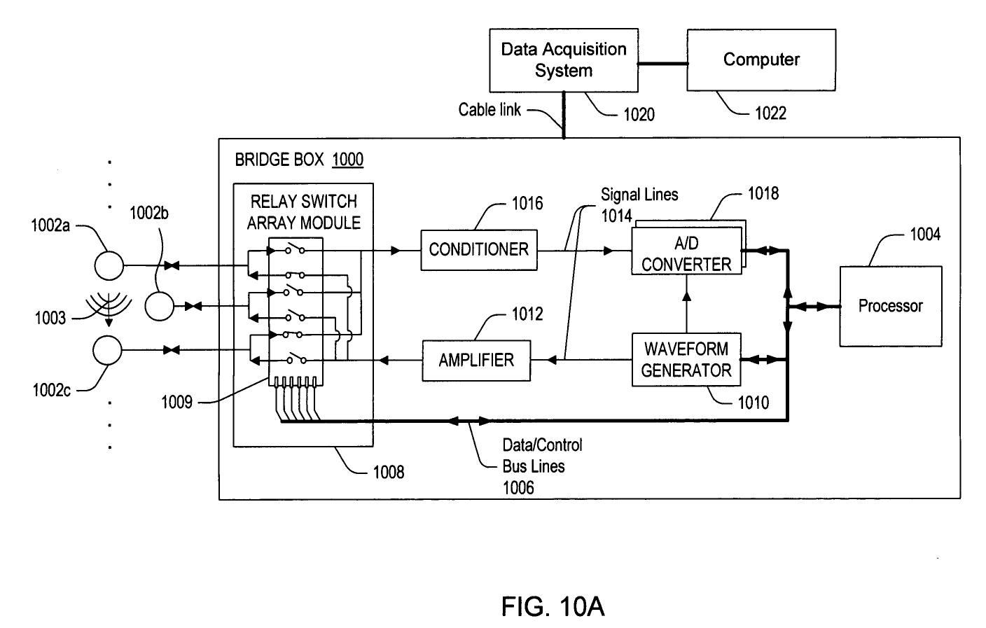

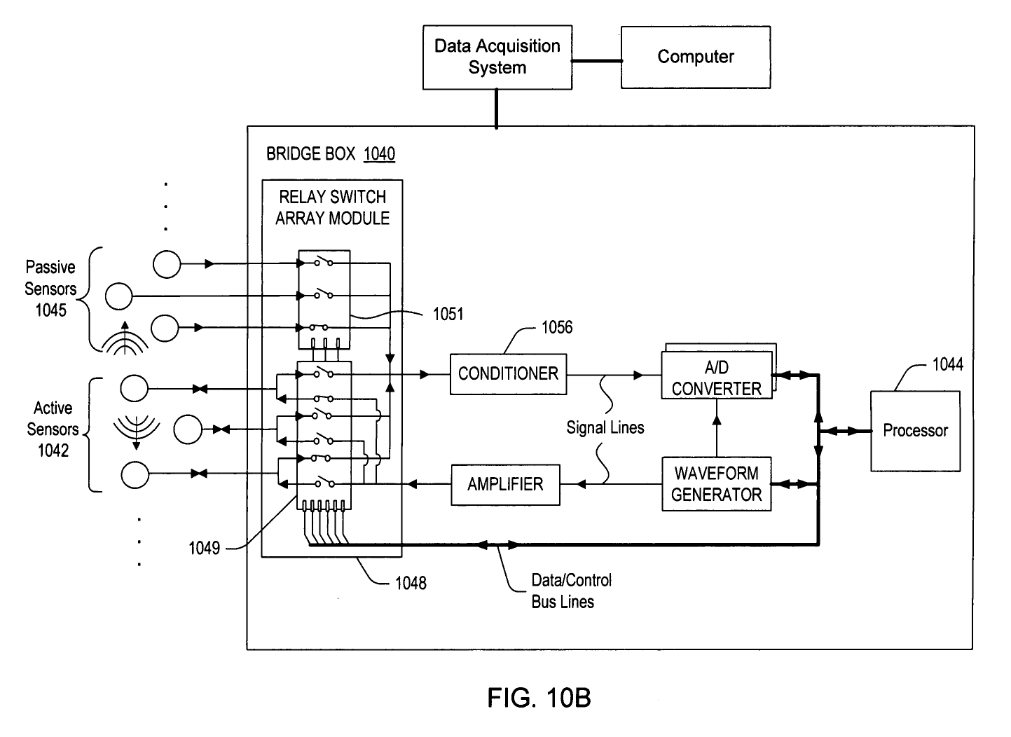

FIG. 10A is a schematic diagram of a structural health monitoring (SHM) system having a bridge box 1000 in accordance with another embodiment of the present teachings. As depicted, the SHM system includes at least one bridge box 1000, active sensors 1002a-1002c, a data acquisition system 1020, and a computer 1022. For brevity, only three active sensors 1002a-1002c are shown in FIG. 10A. However, it should be apparent to those of ordinary skill that the SHM system may include any other suitable number of sensors and the relay switch array module 1008 may have any other suitable number of switches. Likewise, more than one relay switch array module may be included in the bridge box 1000. Also, one or more passive sensors may be included in the SHM system.

The bridge box 1000 receives oscillation signal data from the data acquisition system 1020 connected to the computer 1022 and sends an actuator signal to an active sensor, say 1002a. The oscillation signal data is related to the actuator signal, i.e., in response to the actuator signal, the active sensor 1002a emits a diagnostic wave 1003 that is received by an active sensor 1002c. The bridge box 1000 also processes and relays the sensor signal received by the active sensor 1002c to the computer 1022 via the data acquisition system 1020.

The bridge box 1000 can generate oscillation signal data upon receipt of a command signal from the data acquisition system 1020, send an actuator signal to the active sensor 1002a according to the oscillation signal data, analyze signal data received from the active sensors 1002 to thereby perform digital signal processing (DSP) and obtain structural diagnosis parameters, and send the structural diagnosis parameters to the computer 1022. The computer 1022 may be connected an external control device that can control the bridge box 1000 and communicate data to the bridge box 1000. More information of the structural diagnosis parameters can be found in U.S. Pat. No. 7,286,964 and U.S. patent application Ser. Nos. 11/509,198, 11/827,244, 11/827,319, 11/827,350, and 11/827,415, which are herein incorporated by reference by their entirety.

The bridge box 1000 includes one or more relay switch array modules 1008, one or more A/D converters 1018, a waveform generator 1010, a signal conditioner 1016, a waveform amplifier 1012, and a processor 1004. It is noted that the bridge box 1000 may include multiple number of each component thereof. Also, even though not shown in FIG. 10A for brevity, the bridge box 1000 may include internal memories (such as SRAM and DDRAM), a storage (such as Hardware/Flash memory card), and a logic circuit, such as field-programming-gate-array (FPGA) or complex-programmable-logic-device (CPLD), for handling and processing input/output data transmitted via the data/control bus lines 1006 to/from components of the bridge box 1000. Optionally, the bridge box 1000 may include a DSP processor such that the measured signal can be firstly processed by the FPGA, and the DSP processor can secondly process the processed signal. Furthermore, the bridge box 1000 may include a bus interface controller (not shown in FIG. 10A) for communicating with external host devices, such as the data acquisition system 1020 and a data recorder.

The bridge box 1000 may include, for example, a firmware system having a Windows CE™ operating system or a Linux™ operating system. In another example, the bridge box 1000 has a controller card of Windows™ operating system that corresponds to a processor and is installed in a chassis with a backplane of a compact PCI or a VXI bus, an A/D converter module, a D/A converter, a switch array, and a signal conditioning and amplifying module in the form of a card. In still another example, the bridge box 1000 includes chips having various functions and fabricated using a system-on-chip (SoC) technique. In such a miniature bridge box, the processor 1004, A/D converters 1018, waveform generator 1010, signal conditioner 1016, a relay switch array module controller, an internal memory, an FPGA, and communication devices have a low voltage source and are included in one SoC chip. Also, the amplifier 1012, a switch driver, and switches have a high voltage source and are formed in a CMOS chip by use of a high-voltage CMOS technique.

The processor 1004 communicates with various components of the bridge box 1004 and handles 1/0 requests transmitted from various components of the bridge box 1000 via a local bus. For each component of the bridge box 1000, the processor 1004 reads or writes the I/O value of control/status registers corresponding to the component in a designated memory address. The waveform generator 1010 receives actuating waveform data from the processor 1004 via the data/control local bus lines 1006, generates a high-frequency low-voltage waveform signal using a digital-to-analogue converter (D/A converter), and sends the high-frequency low-voltage waveform signal to the amplifier 1012 via signal lines 1014. Simultaneously, the waveform generator 1010 sends a waveform signal to one of the analogue-to-digital converters (A/D converters) 1018 via the signal lines 1014. The waveform generator 1010 also sends a sync-output control signal to another A/D converter 1018 so that at least two A/D converters 1018 get trigger signals and start sampling. The processor 1004 receives waveform data from one of the A/D converters 1018 and stores the data in a memory.

The amplifier 1012 amplifies a waveform signal into a high-frequency high-voltage pulse signal so that the actuator patch of an active sensor, say 1002a, attached to the host structure can generate a diagnostic wave, such as acousto-ultrasonic wave, having a sufficient intensity. The switch array 1009 directs an electric pulse signal to the active sensor 1002a, causing the sensor to generate the diagnostic wave 1003 that propagates through the host structure to other sensors 1002b-1002c. Each of the sensors 1002b-1002c generates a sensor signal of tens of milivolts in response to the propagated wave and transmits the sensor signal to the switch array 1009. The switch array 1009 directs the sensor signal to the signal conditioner 1016 that amplifies the sensor signal, adjusts a DC offset, filters the sensor signal using a band-pass filter, and transmits the conditioned sensor signal to one of the A/D converters 1018 via the signal lines 1014. The processor 1004 receives the converted sensor signal from one of the A/D converters 1018 and stores into a memory. The processor 1004 measures the difference in time-of-arrival between the waveform data received from two of the AND converters 1018 and the converted sensor signal data received from one of the A/D converters 1018.

The processor 1004 fetches address values of the switches corresponding to an actuator patch channel and a sensor patch channel from a memory. Subsequently, the processor 1004 uses a switch controller (FPGA/CPLD) or a multiplexing logic circuit of the bridge box 1000 to send a control signal to the relay switch array module 1008. Then, the relay switch array module 1008 sends a control signal to an internal switch driver so that the switches in the switch array 1009 are operated to form an actuator patch channel and a sensor patch channel. Upon establishing the channels, the actuator signal is sent to the sensor 1002a and the sensor signal is sent from the sensor 1002c to the processor 1004. The switches of the relay switch array module 1008 include reed relay switches, high-voltage CMOS field-effect transistor (FET) switches, and/or solid-state-relay (SSR) switches.

The waveform generator 1010 and the amplifier 1012 can be replaced by a pulse generator that generates a bipolar pulse train having a higher center frequency than the cut-off frequency of the amplifier 1012 and sends the bipolar pulse to the sensor 1002a. For that purpose, the processor 1004 may generate, instead of using the waveform data, a clock signal set to the actuator excitation frequency, input the clock signal to a CPLD to generate an output control signal within a preset time interval, and cause high-voltage FET switches to generate the bipolar pulse train of a high frequency. Also, a high-voltage filter is used to reduce the noise of the sensor signal and remove high frequency components of the high-voltage pulse train.

In one embodiment, one of the terminals 118a, 118b of the patch sensor 100 (FIG. 1B) is connected to the relay switch array module 1008 to receive a high-voltage waveform signal and the other terminal is connected to a common ground by a single-ended type connection. In such a case, a sensor signal of a low voltage may be affected by a cross-talk or an interference between the two lines connected to the terminals. In another embodiment, to reduce the cross-talk and interference, one of the terminals 118a, 118b is connected to the relay switch array module 1008 to receive a first high-voltage waveform signal and the other terminal is also connected to the relay switch array module 1008 to receive a second high-voltage waveform that has the same waveform but opposite polarity to the first high-voltage wave form signal, i.e., the terminals are connected by a double-ended type connection. In this embodiment, the bridge box 1000 may include two separate amplifiers that respectively generate the first and second high-voltage waveform signals simultaneously. Also, the switch array 1009 includes a pair of switches for each sensor so that the first and second high-voltage waveform signals are simultaneously directed to a sensor. The double-ended type connection allows the operational voltage of the amplifier 1012 to be reduced by a factor of two without compromising the energy of the diagnostic wave 1003 and extends the life expectancy of the bridge box.

FIG. 10B is a schematic diagram of a structural health monitoring (SHM) system having a bridge box 1040 in accordance with another embodiment of the present teachings. As depicted, the SHM system of FIG. 10B is similar to the SHM system of FIG. 10A, with the difference that the relay switch array module 1048 includes two switch arrays 1049, 1051. To provide scheduling the monitoring-time periods allocated to passive sensors 1045, the low-voltage switch array 1051 is coupled to passive sensors 1045, i.e., the switch array 1051 directs only sensor signals to the conditioner 1056, while the high-voltage switch array 1049 is coupled to active sensors 1042.

The relay switch array module 1048 sends control signals to a switch driver of the high-voltage switch array 1049 to open/close a signal channel to one of the active sensors 1042 and to a switch driver of the low-voltage switch array 1051 to open/close a signal channel to one of the passive sensors 1045. The processor 1044 sends the control signals to the relay switch array module 1048 by use of a switch controller (FPGA/CPLD) or a multiplexing logic circuit of the bridge box 1040.

The bridge box 1040 may have the same components as the bridge box 1000, except that the relay switch array module 1048 has two switch arrays 1049, 1051. As in the case of the bridge box 1000 of FIG. 1A, the bridge box 1040 may include internal memories (such as SRAM and DDRAM), a storage (such as Hardware/Flash memory card), a logic circuit, such as FPGA or CPLD, for handling and processing input/output data transmitted to/from components of the bridge box 1040, and a DSP processor. For brevity, detailed description of the components of the bridge box 1040 is not repeated.

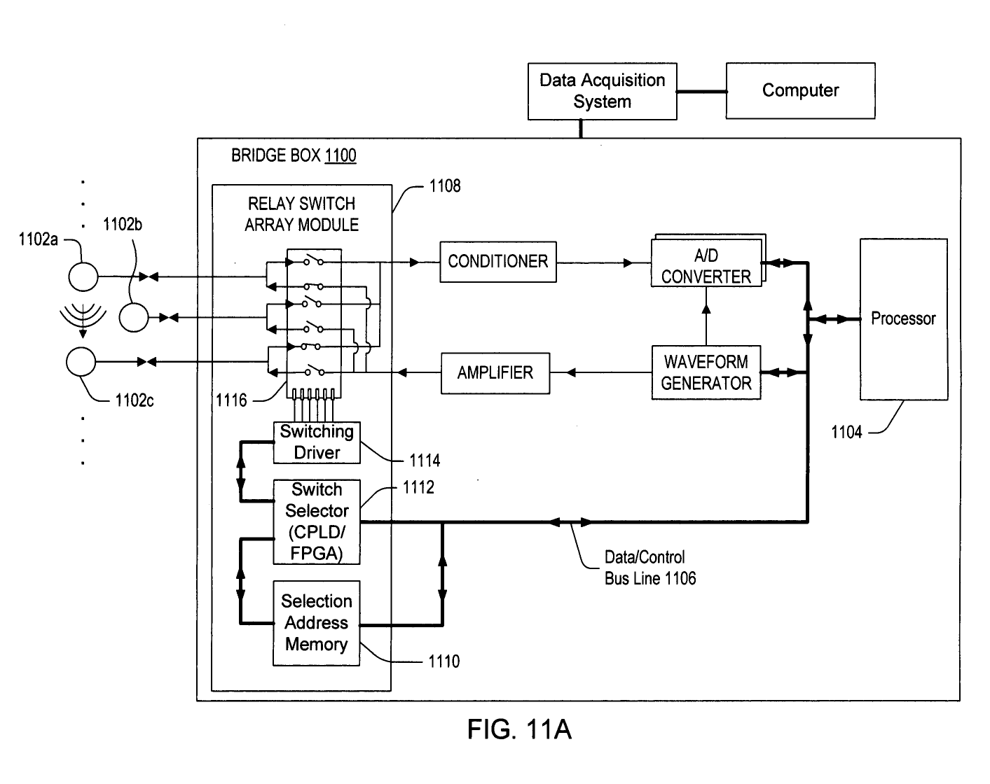

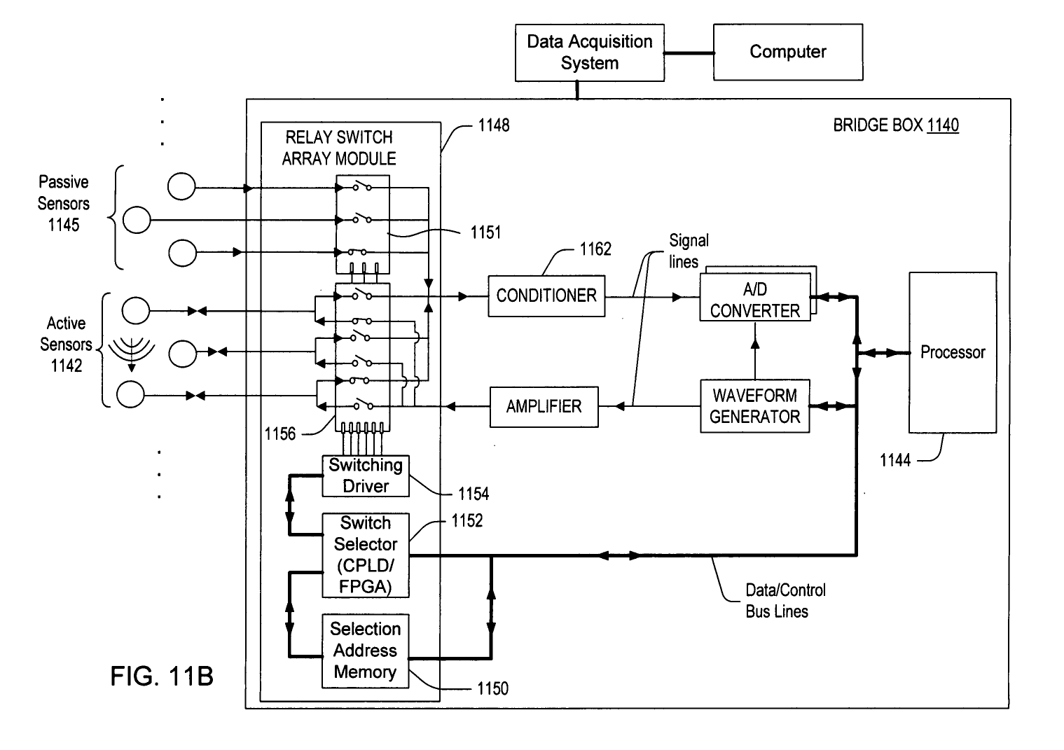

FIG. 11A is a schematic diagram of a structural health monitoring (SHM) system having a bridge box 1100 in accordance with another embodiment of the present teachings. As depicted, the system of FIG. 11A is similar to the system of FIG. 10A, with the difference that the bridge box 1100 includes a switching driver 1114, a switch selector 1112, and a selection address memory 1110.

Also, as in the case of the bridge box 1000 of FIG. 10A, the bridge box 1100 may include internal memories (such as SRAM and DDRAM), a storage (such as Hardware/Flash memory card), a logic circuit, such as FPGA or CPLD, for handling and processing input/output data transmitted to/from components of the bridge box 1100, and a DSP processor. Also, the bridge box 1100 may include more than one relay switch array module and a bus interface controller for communicating with external host devices, such as data acquisition system and data recorder. For brevity, detailed description of the components of the bridge box 1100 is not repeated.

The switch selector 1112 is a multiplexing logic circuit, such as CPLD and FPGA. The selection address memory 1110 stores a list of port addresses corresponding to the sensors 1102, where each element of the list is the resister value of a memory address. More specifically, the selection address memory 1110 includes a range memory space divided into prioritized memory pages, and each paged range memory space includes a list of port addresses. The switch selector 1112 fetches port address values stored in the registers of paged range memory space and sends the fetched port address values to the switching driver 1114 so that the switches in the switch array 1116 are operated to form an actuator patch channel and a sensor patch channel.

The switch selector 1112 may fetch a port address value from the top list in the memory page of the highest priority or a port address at a fixed memory address location in accordance with a preset sequence order stored in a separate networking memory space. The processor 1104 determines and changes the port address value and stores the port address value in the paged memory space range via the data/control bus lines 1106. To analyze sensor signals and establish an optimum network environment among the active sensors 1102, the processor 1104 determines and changes memory address list values of the sequence order and stores the memory address list values in the networking memory space. The switch selector 1112 fetches port address values of the memory address of the paged range memory space, where the memory address is the register value of the networking memory space.

FIG. 11B is a schematic diagram of a structural health monitoring (SHM) system having a bridge box 1140 in accordance with another embodiment of the present teachings. As depicted, the system of FIG. 11B is similar to the system of FIG. 11A, with the difference that the relay switch array module 1148 includes two switch arrays 1151,1156. The low-voltage switch array 1151 is coupled to passive sensors 1145, i.e., the switch array 1151 directs only passive sensor signals to the conditioner 1162, while the high-voltage switch array 1156 is coupled to active sensors 1142.

The relay switch array module 1148 sends control signals to a switch driver of the high-voltage switch array 1156 to open/close a signal channel to one of the active sensors 1142 and to a switch driver of the low-voltage switch array 1151 to open/close a signal channel to one of the passive sensors 1142. The processor 1144 sends the control signals to the relay switch array module 1148 by use of a switch controller (FPGA/CPLD) or a multiplexing logic circuit of the bridge box 1140.

The bridge box 1140 includes the same components as the bridge box 1100, except that the relay switch array module 1148 has two switch arrays 1151, 1156. As in the case of the bridge box 1100 of FIG. 11A, the bridge box 1140 may include internal memories (such as SRAM and DDRAM), a storage (such as Hardware/Flash memory card), a logic circuit, such as FPGA or CPLD, for handling and processing input/output data transmitted to/from components of the bridge box 1140, and a DSP processor. Also, the bridge box 1140 may include more than one relay switch array module and a bus interface controller for communicating with external host devices, such as data acquisition system and data recorder. For brevity, detailed description of the components of the bridge box 1140 is not repeated.

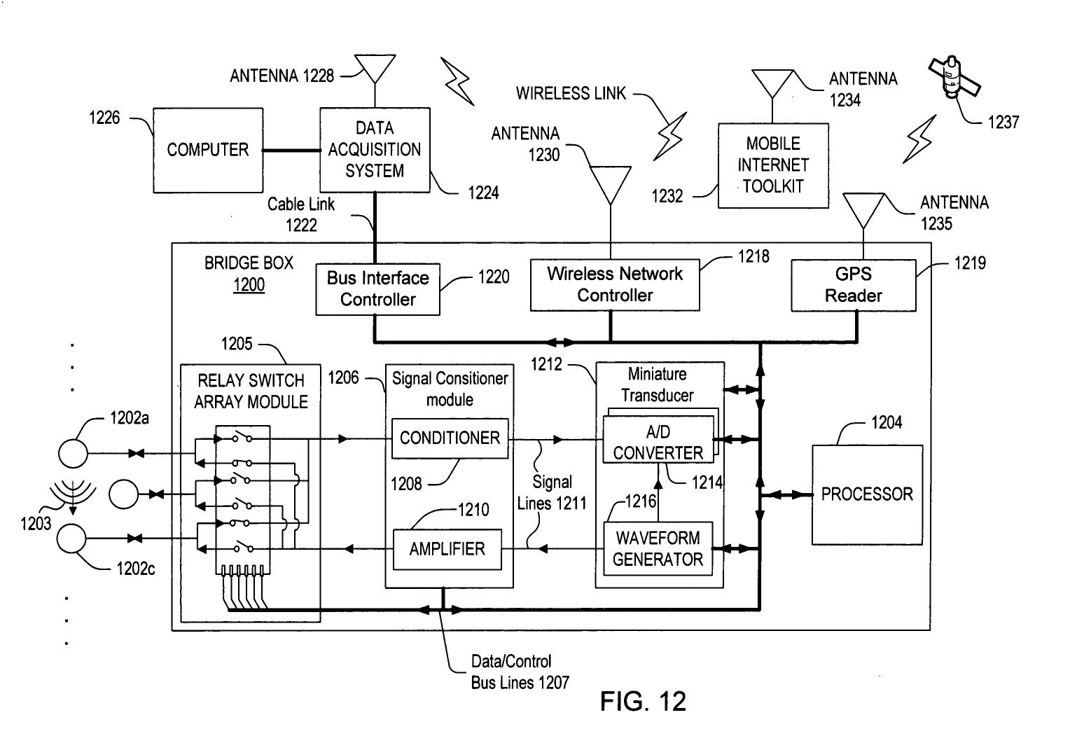

FIG. 12 is a schematic diagram of a structural health monitoring (SHM) system having a bridge box 1200 in accordance with another embodiment of the present teachings. As depicted, the SHM system includes at least one bridge box 1200, patch sensors 1202, a data acquisition system 1224, a computer 1226, and a mobile internet toolkit 1232. The SHM system may communicate with mobile internet toolkit 1232 and a satellite 1237 via a wireless link. In FIG. 12, for brevity, only three active patch sensors 1202 are shown in FIG. 12. However, it should be apparent to those of ordinary skill that the SHM system may include any other suitable number of sensors and the relay switch array module 1205 may have any other suitable number of switches. Also, one or more passive sensors may be included in the SHM system.

The bridge box 1200 receives oscillation signal data from the data acquisition system 1224 via a cable link 1222 and sends an actuator signal to an active sensor 1202a. In response to the actuator signal, the active sensor 1202a emits a diagnostic wave 1203 that is received by an active sensor 1202c. The bridge box 1200 also relays the sensor signal received by the active sensor 1202c to the computer 1226 via the data acquisition system 1224.

The bridge box 1200 can generate oscillation signal data upon receipt of a command signal from the data acquisition system 1224, send an actuator signal to the active sensor 1202a according to the oscillation signal data, analyze signal data received from the active sensor 1202c to thereby perform digital signal processing (DSP) and obtain structural diagnosis parameters, and send the structural diagnosis parameters to the computer 1226. The computer 1226 may be connected to an external control device that can control the bridge box 1200 and communicate data to the bridge box 1200. Optionally, the bridge box 1200 may include a global positioning system (GPS) reader 1219 for calculating the location of the bridge box 1200 and providing the location information by use of a GPS-TRACK satellite 1237 via antenna 1235 attached to the GPS reader 1219. The bridge box 1200 can send its location and structural condition data to the data acquisition system 1224 and the mobile internet toolkit 1232 via the antennae 1235, 1228, and 1234 so that the structural conditions of a mobile host structure/platform, such as vehicle, airplane, or ship, can be remotely monitored by tracking the bridge box 1200 through its GPS reader 1219.

The bridge box 1200 includes at least one relay switch array module 1205, a signal conditioner module 1206, a miniature transducer module 1212, and a processor 1204. The signal conditioner module 1206 includes at least one signal conditioner 1208 and a waveform amplifier 1210. The miniature transducer 1212 includes at least one A/D converter 1214 and a waveform generator 1216. The bridge box 1200 also includes a bus interface controller 1220 for interfacing the data acquisition system 1224 and a wireless network controller 1218 for controlling data transfer via the antennae 1228,1234, and 1230 attached to the data acquisition system 1224, mobile internet toolkit 1232, and the bridge box 1200, respectively. As an example, multiple bridge boxes 1200 may be installed in an airplane to monitor structural conditions of major parts. More specifically, multiple sets of sensors are attached to the major parts of the airplane, and the bridge boxes coupled to the multiple sets of sensors collect the sensor signals, process the sensor signals to analyze the structural conditions of the major parts, and send the analyzed information to the data acquisition system 1224 and the mobile internet toolkit 1232 of the ground control 692 (FIG. 6F). Alternatively, the bridge box 1200 may be connected to a ground diagnosis tool via a cable for maintenance or download of the information and data collected during flights.

The functions and structures of the components of the bridge box 1200 are similar to those of their counterparts of the bridge box 1000 in FIG. 10A. Also, as in the case of the bridge box 1000 of FIG. 1A, the bridge box 1200 may include internal memories (such as SRAM and DDRAM), a storage (such as Hardware/Flash memory card), a logic circuit, such as FPGA or CPLD, for handling and processing input/output data transmitted to/from components of the bridge box 1200, and a DSP processor. For brevity, detailed description of the components of the bridge box 1200 is not repeated.

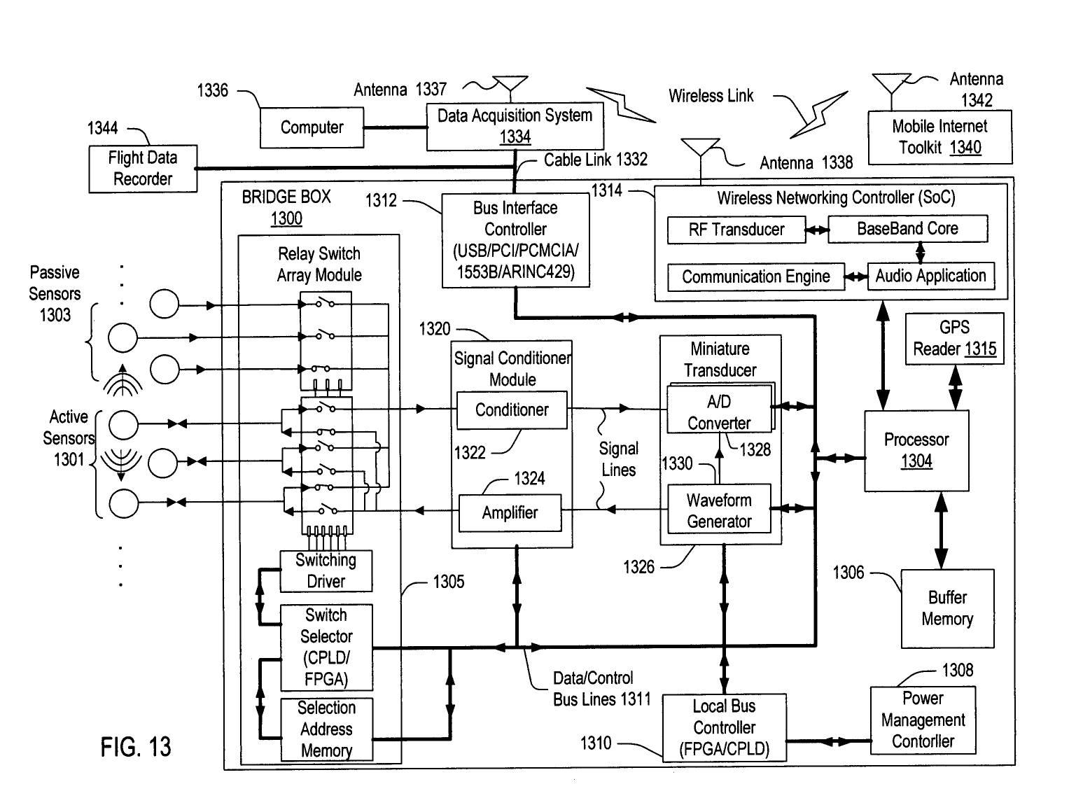

FIG. 13 is a schematic diagram of a structural health monitoring (SHM) system having a bridge box 1300 in accordance with another embodiment of the present teachings. As depicted, the bridge box 1300 includes: at least one relay switch array module 1305; a miniature transducer 1326 having multiple A/D converters 1328 and a waveform generator 1330; a signal conditioner module 1320 having at least one signal conditioner 1322 and a waveform amplifier 1324. The bridge box 1300 also includes: a bus interface controller 1312 for interfacing external host devices, such as a data acquisition system 1334 connected to a computer 1336 and a flight data recorder 1344, via a cable link 1332; and a wireless network controller 1314 for controlling data transfer via the antennae 1337, 1342, and 1338 attached to the data acquisition system 1334, a mobile internet toolkit 1340, and the bridge box 1300, respectively. The wireless networking controller 1314 may include an RF transducer, a baseband core, an audio application, and a communication engine. The bridge box 1300 also includes a GPS reader 1315 for communicating location information to a GPS-TRACK satellite via a wireless link.

The wireless network controller 1314 is managed by I/O requests of the processor 1304 transmitted via data/control bus lines 1311 and operates as an integrated communication module for wireless networking among bridge boxes and for communication between the bridge box 1300 and the mobile internet toolkit 1340. The bus interface controller 1312 bridges and controls communications between a local bus and a host bus, such as USB, peripheral component interconnect (PCI), personal computer memory card international association (PCMCIA), Mil-Std-1553B, and aeronautical radio, incorporated 429 (ARINC429).

The bridge box 1300 also includes a buffer memory 1306 coupled to the processor 1304, a power management controller 1308, and a local bus controller (FPGA/CPLD) 1310 coupled to the miniature transducer 1326. Also, even though not shown in FIG. 13 for brevity, the bridge box 1200 may include internal memories (such as SRAM and DDRAM), a storage (such as Hardware/Flash memory card), a logic circuit for handling and processing input/output data transmitted to/from components of the bridge box 1300 via the data/control bus lines 1311, and a DSP processor. The functions and structures of the components of the bridge box 1300 are similar to those of their counterparts of the bridge box 1140 in FIG. 11B. For brevity, detailed description of the components of the bridge box 1300 is not repeated.

The relay switch array module 1305 has a structure and functions similar to those of the relay switch array module 1148 (FIG. 11B). For instance, a low-voltage switch array is coupled to passive sensors 1303 and a high-voltage switch array is coupled to active sensors 1301. The bridge box 1300 may be applied to various types of host structures. For example, one or more bridge boxes 1300 may be installed in an airplane and used to store the information of structural conditions and flight safety or transmit the information to a wireless data acquisition system of a ground control via a wireless link. (Alternatively, the bridge box 1300 may be connected to a ground diagnosis tool via a cable for maintenance or download of the information collected during flights.) Such a switching-based SHM system has advantages over the conventional health-and-usage-monitoring-system (HUMS) that is based on sensor signals from a power generating system and a navigation control system of the airplane.

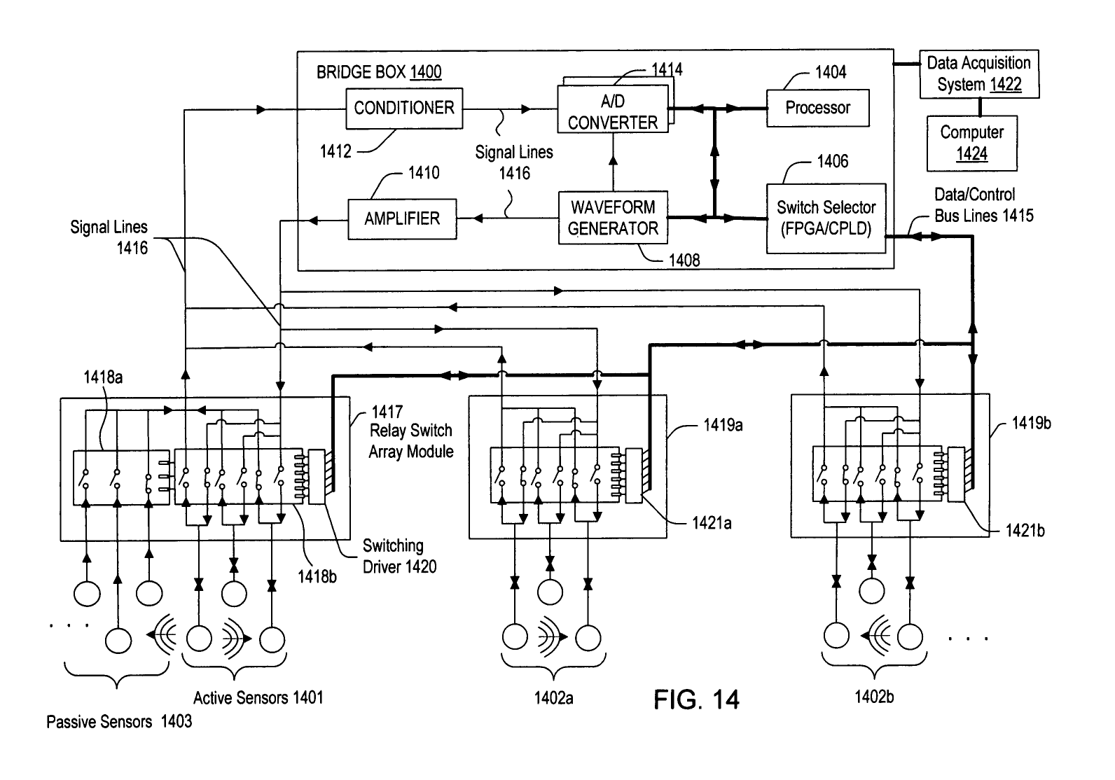

FIG. 14 is a schematic diagram of a structural health monitoring (SHM) system having a bridge box 1400 in accordance with another embodiment of the present teachings. As depicted, the SHM system includes: a bridge box 1400; active sensors 1401, 1402a-b; passive sensors 1403; a data acquisition system 1422; a computer 1424; and relay switch array modules 1417, 1419a-1419b disposed outside the bridge box 1400 and connected to the bridge box via signal lines 1416 and data/control bus lines 1415.

The bridge box 1400 includes: a switch selector 1406, at least one A/D converter 1414, a waveform generator 1408, a signal conditioner 1412, a waveform amplifier 1410, and a processor 1404. Also, even though not shown in FIG. 14 for brevity, the bridge box 1400 may include internal memories (such as SRAM and DDRAM), a storage (such as Hardware/Flash memory card), a logic circuit for handling and processing input/output data transmitted to/from components of the bridge box 1400 via the data/control bus lines 1415, and a DSP processor. The functions and structures of the components of the bridge box 1400 are similar to those of their counterparts of the bridge box 1000 in FIG. 10A. For brevity, detailed description of the components of the bridge box 1400 is not repeated.

The relay switch array module 1417 includes: two switch arrays 1418a and 1418b that are respectively connected to passive sensors 1403 and active sensors 1401; and a switching driver 1420 for actuating the two switch arrays. The relay switch array module 1419a (or 1419b) includes one switch array coupled to active sensors 1402a (or 1402b) and a switching driver 1421a (or 1421b). It should be apparent to those of ordinary skill that the bridge box 1400 can be coupled to any other suitable number of relay switch array modules and that each relay switch array module can be coupled to any other suitable number of active and/or passive sensors.

The processor 1404 uses switch selector (FPGA/CPLD) 1406 or a multiplexing logic circuit of the bridge box 1400 to send a control signal to one of the remote relay switch array modules 1417, 1419a-b so that the remote relay switch array modules can control the switch arrays.

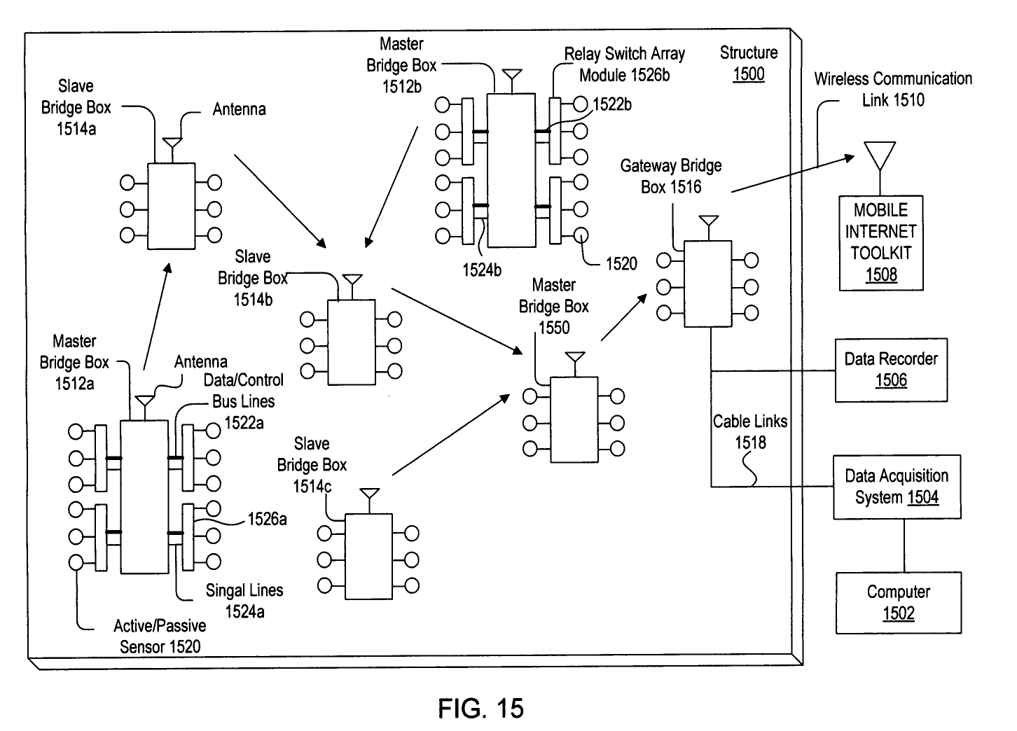

FIG. 15 shows a schematic diagram of a wireless structural health monitoring system to monitor/diagnose the structural condition of a host structure 1500 in accordance with another embodiment of the present teachings. As depicted, the wireless SHM system includes: active/passive sensors 1520a; master bridge boxes 1512a-b connected to relay switch array modules 1526a-b via signal lines 1524a-b and data/control bus lines 1522a-b; a master bridge box 1550; slave bridge boxes 1514a-c; a gateway bridge box 1516 connected to a data recorder 1506, a data acquisition system 1504, and a computer 1502 via cable links 1518. Each of the master bridge boxes 1512a-b, 1550, slave bridge boxes 1514a-c, and gateway bridge box 1516 has an antenna for wireless communication between themselves and the mobile internet toolkit 1508.

In the wireless SHM system of FIG. 15, the master and slave bridge boxes are not directly connected to the devices outside the structure 1500 via cables, which reduces the installation and maintenance efforts of the system. The master bridge boxes 1512 and slave bridge boxes 1514 form a wireless bridge-box communication network utilizing an Ad-hoc network for wireless bridge boxes and, more specifically, the bridge boxes comprise a wireless personal area network (WPAN) using the IEEE 802.15.4 based Bluetooth™ communication technology, IEEE 802.15.4 based ZigBee™ communication technology, Wi-Fi™ communication technology, or GPRS/GSM (general packet radio service/global system for mobile communications) standard. In the present document, the master and slave bridge boxes are described to use the Bluetooth™ communication technology. However, other communication technology can be used instead, taking into account factors, such as application focus, system resources, battery life, network size, bandwidth, transmission range, reliability, cost, and accessibility.

To establish a wireless network of sensor-clustered bridge boxes, the bridge boxes are connected using the Bluetooth™ communication technology. A Piconet is a wireless personal area network (WPAN) and allows master/slave bridge boxes in a region to share a frequency band, which prevents any interference from bridge boxes of other Piconet. Each Piconet has one master bridge box and communicate with other master bridge boxes to form a Scatternet. In a bridge box WPAN based on the Zigbee™ communication technology, RFDs (reduced-function-device) are used as network-edge devices and functions and features of IEEE 802.15.4 are provided. Also, bridge boxes may include full-function-devices (FFD) and that can be used as network routers or network-edge devices, and the bridge boxes may form a personal-network-network (PAN).

The master bridge boxes 1512, 1550 and the slave bridge boxes 1514 form a Piconet and/or a Scatternet based on the Bluetooth™ communication technology. If the bridge box WPAN for the wireless SHM system employs the IEEE 802.15.4 based ZigBee™ technology, the master bridges 1512a-b are full-function devices (FFD) while the mater bridge 1550 is a FFD/PAN (personal-area-network) coordinator and the slave bridge boxes 1514a-c are reduced-function devices (RFD). The gateway bridge box 1516 communicates with the data acquisition system 1504 via a wireless communication link as well as the cable links 1518.

Each of the master and slave bridge boxes 1512, 1550, and 1514 includes a wireless network controller having a processing module based on the Bluetooth™ communication technology. The gateway bridge box 1516 includes a wireless network controller having a Bluetooth processing module and a remote communication module, such as, CDMA, GSM, or Wireless LAN communication module. The master bridge boxes 1512, 1550 can process sensor signals received from sensors 1520 connected thereto and send the processed data to the gateway bridge box 1516. In the case where the bridge boxes are disposed close to each other, a master bridge box can also perform the functions of a gateway bridge box. The gateway or master bridge box can send data to the mobile internet toolkit 1508 and/or the computer 1502 by use of Ipv6 (Internet Protocol version 6) based BcN (Broadband Convergence Network), where the BcN includes a WAP/ME (Wireless Application Protocol/Mobile Explorer), Intranet, LAN (Local Area network), PSTN (Public Switched Telephone Network), MCN (Mobile Communication Network), and BCN/SGS (Broadcasting Communication Network with Satellite and Ground Systems).

The master (FFD/PAN) bridge box 1550 receives monitoring data from the slave (RFD) bridge boxes 1514 and, when the amount of the received data exceeds a preset threshold value, sends the data to the mobile internet toolkit 1508, the data acquisition system 1504, and the computer 1502 by use of a CDMA/GSM MCN or Wireless/Ethernet LAN. A master bridge box can communicate with a mobile device using a CDMA/GSM MCN and send a warning message to a mobile device within a CDMA zone. A master bridge box may include an additional serial controller for controlling passive sensors that have a communication capability using RS-232 standard and for receiving sensor signals from the passive sensors.

The master (FFD/PAN) bridge box 1550 may include a control module for handling an emergency situation and sending a warning signal to an external device. Each of the master (FFD/PAN) bridge box 1550 and the slave bridge boxes 1514 may include: a watch dog timer to perform self-check operations and prevent errors; and an LED (Light Emitting Diode) for allowing a human operator to check operational status of the sensors.

While the present invention has been described with reference to the specific embodiments thereof, it should be understood that the foregoing relates to preferred embodiments of the invention and that modifications may be made without departing from the spirit and scope of the invention as set forth in the following claims.

What is claimed is:

1. A diagnostic system for monitoring structural health conditions by use of a plurality of patch sensors attached to an object, each of the patch sensors being adapted to perform at least one of generating a wave upon receipt of an actuator signal and developing a sensor signal, the system comprising:
at least one bridge box including:
at least one analog-to-digital converter(ADC) for converting the sensor signal to a digital signal; and
at least one relay switch array module that has a plurality of switches,
wherein the switches are adapted to establish a channel between a selected one of the patch sensors and the ADC.

2. A diagnostic system as recited in claim 1, wherein the bridge box further includes a signal conditioner adapted to perform at least one of amplifying the sensor signal, adjusting a DC offset of the sensor signal, and filtering the sensor signal.

3. A diagnostic system as recited in claim 1, wherein the bridge box further includes a waveform generator for generating the actuator signal and wherein the switches are adapted to establish a channel between a selected one of the patch sensors and the waveform generator.

4. A diagnostic system as recited in claim 3, wherein the bridge box further includes a miniature transducer having the ADC and the waveform generator.

5. A diagnostic system as recited in claim 1, wherein the bridge box further includes an amplifier for amplifying the actuator signal.

6. A diagnostic system as recited in claim 1, wherein the bridge box further includes a pulse generator for generating a bipolar pulse train.

7. A diagnostic system as recited in claim 1, wherein the relay switch array module is disposed inside the bridge box.

8. A diagnostic system as recited in claim 1, wherein the bridge box further includes a selection address memory for storing port addresses corresponding to the patch sensors and a switch selector for fetching one or more of the port addresses from the selection address memory.

9. A diagnostic system as recited in claim 1, wherein the bridge box further includes a processor for handling input/output requests transmitted from one or more components of the bridge box.

10. A diagnostic system as recited in claim 1, wherein the bridge box further includes at least one of a field-programmable-gate-array and a complex-programmable-logic-device.

11. A diagnostic system as recited in claim 1, wherein the system comprises a first switch array module coupled to at least one active sensor and a second switch array module coupled to at least one passive sensor.

12. A diagnostic system as recited in claim 1, wherein the bridge box further includes a digital signal processing (DSP) processor for processing the sensor signal.

13. A diagnostic system as recited in claim 1, wherein the bridge box includes at least one SoC chip comprising a switch array module, an analog-to-digital converter, a digital-to-analog converter, a signal conditioner, a field-programmable-gate-array, and a processor.

14. A diagnostic system as recited in claim 1, further comprising:
a data acquisition system coupled to the bridge box via at least one of a cable link and a wireless link and operative to generate oscillation signal data associated with the actuator signal and to receive the sensor signal.

15. A diagnostic system as recited in claim 14, further comprising:
a computer connected to the data acquisition system and adapted to operate the patch sensors.

16. A diagnostic system as recited in claim 14, wherein the bridge box further includes a bus interface controller for interfacing the data acquisition system.

17. A diagnostic system as recited in claim 14, wherein the bridge box further includes a wireless network controller for communicating with the data acquisition system via the wireless link.

18. A diagnostic system as recited in claim 17, wherein the wireless network controller includes an RF transducer, a baseband core, a communication engine, and an audio application.

19. A diagnostic system as recited in claim 14, wherein the wireless link is established by use of a conformal load-bearing antenna.

20. A diagnostic system as recited in claim 1, further comprising:
a mobile internet toolkit adapted to communicate with the bridge box via a wireless link.

21. A diagnostic system as recited in claim 1, wherein the bridge box further includes a global-positioning-system (GPS) reader for communicating with a GPS-TRACK satellite via a wireless link.

22. A diagnostic system as recited in claim 1, wherein the system includes a plurality of bridge boxes forming a wireless personal area network.

23. A diagnostic system as recited in claim 22, wherein each of the bridge boxes is one of a full-function device (FFD), an FFD/personal-area-network (PAN) device, and a reduced-function device (RFD).

24. A diagnostic system as recited in claim 22, further comprising a data acquisition system,
wherein each of the bridge boxes is one of a master bridge box, a slave bridge box, and a gateway bridge box and wherein the gateway bridge box communicates with the data acquisition system via at least one of a wireless link and a cable link.

25. A diagnostic system as recited in claim 24, wherein the gateway bridge box includes a remote communication module selected from a group consisting of a CDMA module, a GSM module, a Wireless LAN communication module.
